(19) United States
(12) Patent Application Publication
(10) Pub. No.: US 2026/0229223 A1
(43) Pub. Date: Aug. 6, 2026

(54) Training Speech Recognition Models Using On-The-Fly Code-Switch Simulation With Monolingual Audio Data

(71) Applicant: Oracle International Corporation, Redwood Shores, CA (US)

(72) Inventors: Astik Biswas, Kolkata (IN); Amin Abdaoui, Toulouse (FR); Oleg Gennadievich Shevelev, Chislehurst (GB); Vivek Tyagi, Dublin (IE); Abdelmoumene Boumadane, Paris (FR)

(73) Assignee: Oracle International Corporation, Redwood Shores, CA (US)

(21) Appl. No.: 19/090,785

(22) Filed: Mar. 26, 2025

Related U.S. Application Data
(60) Provisional application No. 63/754,211, filed on Feb. 5, 2025.

(51) Int. Cl. G10L 15/06; G10L 13/033; G10L 13/08

(52) U.S. Cl. CPC G10L 15/063; G10L 13/033; G10L 13/086

(57) ABSTRACT

Techniques are disclosed for improving automatic speech recognition (ASR) of code-switched speech, such as for Hindi-English, using two distinct approaches. The first approach combines limited, in-domain, code-switched data with monolingual data and implements on-the-fly code switch simulation during training. The second approach leverages language models (LMs) to generate domain-specific, code-switched utterances through few-shot prompting, followed by text-to-speech (TTS) synthesis to create training data. The first approach, using language-specific prompts and on-the-fly code mixing, achieves significant improvements with minimal in-domain data. The second approach, utilizing synthetic data generated through language model prompting and TTS, achieves a relative improvement over the pretrained model without using real, in-domain data. Both approaches are adaptable to other speech recognition systems and language pairs.

### INCORPORATION BY REFERENCE; DISCLAIMER

Each of the following applications are hereby incorporated by reference: U.S. Provisional Application No. 63/754,211 filed on Feb. 5, 2025. The applicant hereby rescinds any disclaimer of claims scope in the parent application(s) or the prosecution history thereof and advises the USPTO that the claims in the application may be broader than any claim in the parent application(s).

### TECHNICAL FIELD

This disclosure relates generally to the technical field of automatic speech recognition. More particularly, this disclosure relates to the technical fields of code-switched speech recognition systems.

### BACKGROUND

Code-switching, defined as speakers alternating between multiple languages within the same conversation, poses significant challenges for Automatic Speech Recognition (ASR) systems. This is particularly pronounced in regions like India, where seamless transitions between languages are common in everyday speech. Current state-of-the-art ASR systems, while excelling at monolingual tasks, struggle to accurately recognize and transcribe code-switched speech. These systems often exhibit various issues, such as deafness to language switches, translation errors, and hallucinations, particularly when processing the first thirty seconds of speech for language detection.

The challenge is especially acute for Indic languages, where code-switching occurs dynamically and spontaneously. Traditional approaches, like speaker diarization and audio segmentation, have proven impractical, as they introduce unacceptable latency and fail when a single speaker switches languages within the same segment. Moreover, the scarcity of labeled training data for code-switched speech severely limits the effectiveness of modern, transformer-based ASR systems in handling these scenarios.

Previous research efforts have attempted to address these limitations through various technical approaches. Some have focused on incorporating monolingual speech into code-switch ASR systems or enhancing pronunciation models to handle accents and variations. Others have explored text-based solutions, such as augmenting code-switching text from monolingual corpora, to improve language models. From a modeling perspective, frameworks like Mixture of Experts (MoE), with separate encoders and decoders for different languages, have been developed. However, these approaches have not fully resolved the technical challenge of how an ASR system can effectively handle code-switched speech, particularly in Indic languages, when faced with limited training data and the need for real-time processing without introducing significant latency.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for training a speech recognition model using synthetic, code-switched audio samples generated from audio samples in different languages according to one or more embodiments;

FIG. 2 illustrates a system for evaluating synthetic, code-switched audio samples against a maximum duration threshold and sorting them into subsets based on threshold compliance according to one or more embodiments;

FIG. 3 illustrates a system for generating synthetic, code-switched audio samples by matching and combining audio samples from the same speaker across different languages according to one or more embodiments;

FIG. 4 illustrates a system for selecting and combining language-specific audio samples based on code-switch compatibility between words to generate synthetic, code-switched audio according to one or more embodiments;

FIG. 5 illustrates a system for generating synthetic, code-switched audio samples by analyzing a document corpus and detecting second language words that meet selection criteria according to one or more embodiments;

FIG. 6 illustrates a system for generating synthetic, code-switched audio samples using a text-to-speech system while maintaining speaker characteristics from audio samples in different languages according to one or more embodiments;

FIG. 7 illustrates a system for improving code-switching capabilities in automatic speech recognition through language model training and decoder fine-tuning according to one or more embodiments;

FIG. 8 illustrates a system for fine-tuning a decoder portion of a transformer-based ASR model while maintaining an unchanged encoder portion during code-switching adaptation according to one or more embodiments;

FIG. 9 illustrates a system for fine-tuning a decoder portion by replacing cross-attention output with a trainable bias vector and predicting language switch positions using language tokens according to one or more embodiments;

FIG. 10 illustrates a system for generating code-switched training sentences through language model bi-gram generation, filtering, and synonymous variation creation according to one or more embodiments;

FIG. 11 illustrates a system for generating code-switched training sentences by creating bi-grams from two languages and using a language model to produce natural flowing sentences according to one or more embodiments;

FIG. 12 illustrates a system for generating domain-specific, code-switched training sentences using a language model with specialized prompts for educational, healthcare, and clinical domains according to one or more embodiments;

FIG. 13 illustrates a system for fine-tuning a decoder portion of an ASR model using language-specific bias embeddings for multiple languages during training according to one or more embodiments;

FIG. 14 illustrates a system for performing two-stage fine-tuning of a transformer-based ASR model using code-switched audio data and code-switched training sentences according to one or more embodiments;

FIG. 15 illustrates a system for training a language model using code-switched sentences to boost vocabulary coverage and complement transformer-based ASR recognition of code-switched patterns according to one or more embodiments;

FIG. 16 illustrates an example transformer model architecture that may be used in the implementation of a language model according to one or embodiments; and

FIG. 17 is a block diagram that illustrates an example computer system upon which one or more embodiments are implemented.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In some embodiments, well-known structures and devices are shown in the figures in block diagram form to avoid unnecessarily obscuring the embodiment.
1. GENERAL OVERVIEW
2. TRAINING SPEECH RECOGNITION MODELS USING ON-THE-FLY CODE-SWITCH SIMULATION WITH MONOLINGUAL AUDIO DATA
   2.1 DURATION THRESHOLD CHECK
   2.2 SPEAKER MATCHING
   2.3 AUDIO-SAMPLE CODE-SWITCH SELECTION
   2.4 CODE-SWITCHED AUDIO GENERATION
   2.5 TEXT-TO-SPEECH WITH SPEAKER CHARACTERISTICS
3. LANGUAGE MODEL-BASED SYNTHETIC DATA GENERATION FOR CODE-SWITCHING AUTOMATIC SPEECH RECOGNITION
   3.1 TRANSFORMER-BASED ASR FINE-TUNING
   3.2 DECODER FINE-TUNING
   3.3 CODE-SWITCHED BI-GRAM GENERATION
   3.4 CODE-SWITCHED TRAINING SENTENCE GENERATION
   3.5 DOMAIN-SPECIFIC CODE-SWITCHED CONTENT GENERATION
   3.6 TWO-STAGE FINE-TUNING PROCESS
   3.7 LANGUAGE-SPECIFIC BIAS EMBEDDINGS
   3.8 LANGUAGE MODEL CONFIGURATION FOR CODE-SWITCHED ASR
4. EXAMPLE EMBODIMENT
5. PRACTICAL APPLICATIONS; ADVANTAGES; IMPROVEMENTS
6. EXAMPLE LANGUAGE MODEL ARCHITECTURE
7. COMPUTER NETWORKS AND CLOUD NETWORKS
8. HARDWARE OVERVIEW
9. MISCELLANEOUS; EXTENSIONS

### 1. General Overview

One or more embodiments provide techniques for training a speech recognition model to handle code-switched speech by leveraging monolingual audio data to create synthetic training examples. These embodiments receive two sets of audio samples—one set in a first language and another set in a second language. During the training process, these embodiments select subsets from each language's audio samples and combine them to generate synthetic code-switched audio samples that encompass speech in both languages. The synthetic samples are then evaluated against training constraints to determine their suitability for model training. Some synthetic samples may satisfy these constraints, while others may not. One or more embodiments then use the synthetic, code-switched samples that meet the training constraints to train the speech recognition model. This approach allows the model to learn how to handle code-switching between languages even when actual code-switched training data is scarce by creating controlled synthetic examples from existing monolingual audio data.

One or more embodiments improve the code-switching capabilities of automatic speech recognition (ASR) systems through a systematic data generation and model adaptation approach. In these embodiments, a language model first receives example inputs that demonstrate code-switching patterns between two different languages. Using these examples as guidance, the language model generates a collection of code-switched N-grams, where each N-gram combines words from both languages. Importantly, these N-grams capture natural language mixing patterns based on the provided examples. The language model then leverages these N-grams to produce a comprehensive training dataset encompassing complete code-switched sentences. Finally, these embodiments use this synthetically generated training dataset to fine-tune specifically the decoder portion of a transformer-based ASR model. This process enhances the ASR model's ability to handle speech that switches between multiple languages, addressing the common challenge of limited code-switched training data in ASR development. These embodiments are particularly valuable for improving ASR performance in multilingual communities where speakers frequently mix languages within the same conversation.

One or more embodiments described in this Specification and/or recited in the claims may not be included in the General Overview section.

### 2.0 Training Speech Recognition Models Using On-the-Fly Code-Switch Simulation With Monolingual Audio Data

One or more embodiments will now be described with respect to the figures. In one or more embodiments, a system depicted in a figure may include more or fewer components than the components illustrated in the figure. The components illustrated in the figure may be local to or remote from each other. The components illustrated in the figure may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in Section 7, titled “Computer Networks and Cloud Networks.” In one or more embodiments, one or more operations performed by a system illustrated in a figure may be modified, rearranged, or omitted. Accordingly, the particular sequence of operations illustrated in a figure should not be construed as limiting the scope of one or more embodiments.

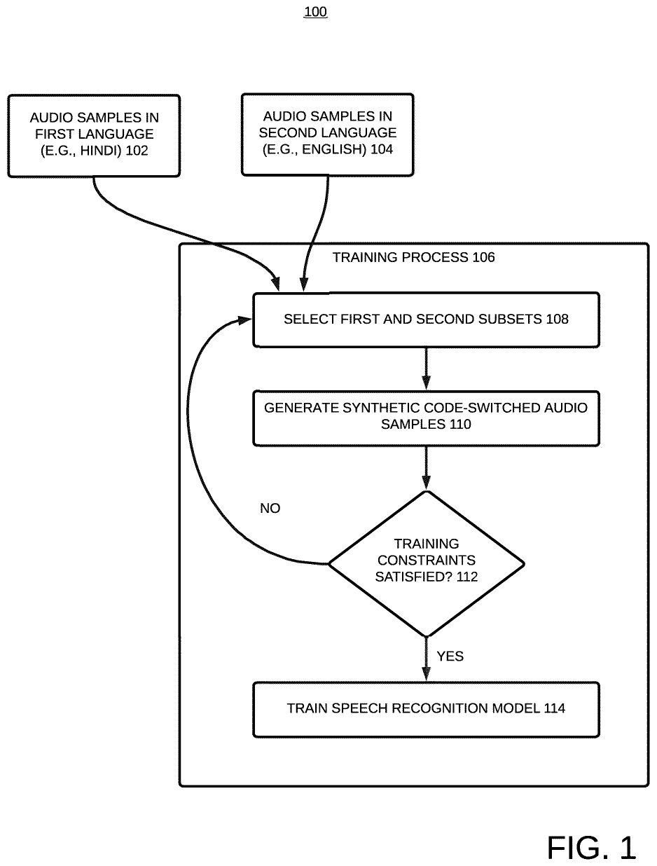

FIG. 1 illustrates a system 100 for training a speech recognition model using synthetic, code-switched audio samples generated from audio samples in different languages according to one or more embodiments.

One or more embodiments train a speech recognition model using synthetic, code-switched audio samples generated from audio samples in different languages. The process begins by receiving two sets of audio samples—one set 102 in a first language and another set 104 in a second language. The training process 106 then selects subsets from both language samples to create synthetic code-switched audio content (Operation 108).

The training process 106 generates synthetic, code-switched audio samples by combining the selected subsets from both languages (Operation 110). Each resulting synthetic sample includes audio content from both the first and second languages, creating mixed-language audio samples. This approach creates training data that represents real-world scenarios where speakers mix multiple languages in their speech.

One or more embodiments evaluate the newly generated, synthetic, code-switched samples against training constraints (Operation 112). The training process 106 identifies two categories of samples; those that satisfy the training constraints (first subset) and those that do not (second subset). This evaluation ensures the quality and usefulness of the synthetic samples for training purposes.

The training process 106 then trains the speech recognition model using the first subset of synthetic, code-switched samples—those that met the training constraints (Operation 114). By using the qualifying samples, one or more embodiments ensure the model learns from high-quality, representative examples of code-switched speech. This selective training approach helps develop a more robust and accurate speech recognition model capable of handling mixed-language input.

One or more embodiments include a first plurality of audio samples in a first language 102 that serves as input for generating synthetic, code-switched speech data. This first plurality of audio samples represents monolingual speech data in one language. The system uses these audio samples as part of an on-the-fly, code-switch simulation process during model training. During training, the system randomly selects subsets of these first language audio samples and combines the audio samples with audio samples in a second language to create synthetic, code-switched training examples. The first plurality of audio samples helps expose the speech recognition model to diverse language transition points and improves the speech recognition model's ability to handle code switching between languages. The audio samples are processed according to metadata and language tags to ensure the audio samples meet duration and token constraints required for effective, transfer-based, ASR model fine-tuning. By incorporating these monolingual audio samples from the first language, one or more embodiments address the challenge of limited, code-switched training data availability while improving the model's robustness in handling language switches.

One or more embodiments use a second plurality of audio samples in a second language 104 as training data for improving code-switched, automatic speech recognition. The second plurality of audio samples represents monolingual out-of-domain data in one of the target languages such as English audio data from a public multilingual speech corpus. The system selects portions of these second language audio samples and combines the second language audio samples with portions of first language audio samples to create synthetic, code-switched training data during the training process. This on-the-fly code mixing simulation helps expose the speech recognition model to diverse language transition points without requiring expensive collection of real, code-switched speech data. The second plurality of audio samples may meet certain duration and token constraints to enable seamless integration into the training pipeline. By incorporating these second language audio samples through controlled combination with first language samples, one or more embodiments enhance the model's ability to handle natural language switching between the two languages during inference.

One or more embodiments execute a training process 106 that adapts a speech recognition model to handle code-switched speech between two languages. The training process 106 operates by first receiving monolingual audio samples in two different languages, such as Hindi and English. During execution, the training process 106 selects subsets of audio samples from each language to create synthetic, code-switched training data through on-the-fly combination. The process validates the generated synthetic samples against training constraints. Training constraints may include duration limits and token requirements that ensure the synthetic data is suitable for transfer-based, ASR model fine-tuning. The training process 106 filters out synthetic samples that do not meet these constraints. The training process 106 then uses the valid synthetic, code-switched samples to train the speech recognition model. This approach allows the model to learn language transitions at code-switch points without requiring large amounts of real, code-switched training data. The training process 106 represents a component for addressing the challenges of limited, code-switched training data availability while improving the model's ability to handle language switching.

One or more embodiments select first and second subsets of audio samples from monolingual data pools to generate synthetic, code-switched training data. The selection process targets Hindi monolingual audio samples as a first subset and English monolingual audio samples as a second subset. The selection process occurs during the on-the-fly, code-switch simulation process. The system draws from hours each of Hindi and English monolingual out-of-domain data. These selected subsets serve as building blocks for creating synthetic, code-switched audio samples. The selection process ensures the audio samples meet specific duration and token constraints required for effective, transfer-based, ASR model fine-tuning. The system uses metadata, including language tags, to guide the selection process. This selection step enables the subsequent random concatenation of audio samples from different languages within each training batch. By carefully selecting appropriate subsets from each language, the system can create diverse code switch points that improve the model's ability to handle language transitions.

One or more embodiments generate synthetic, code-switched audio samples (Operation 110) by combining monolingual audio samples during model training to address the scarcity of code-switched training data. The system selects subsets of audio samples from two different languages and combines the audio samples to create synthetic, code-switched samples that include both languages. This process occurs on-the-fly during training through random concatenation of audio segments and their corresponding transcriptions. The system applies language tags to guide the combination process and ensures the generated samples meet specific duration and token constraints required for effective model training. By creating these synthetic, code-switched samples, one or more embodiments expose the speech recognition model to diverse language switch points, which helps improve the speech recognition model's ability to handle real-world, code-switching scenarios. The system evaluates each generated sample against training constraints and uses those samples that satisfy the requirements for model training. This approach provides a cost-effective way to augment training data without requiring expensive collection of real, code-switched audio recordings.

One or more embodiments determine if synthetic, code-switched audio samples satisfy training constraints during the model training process (Operation 112). The determination process evaluates metadata, including language tags, and ensures that new audio samples meet specific duration and token constraints. These constraints enable transfer-based, ASR model fine-tuning. The training constraints verification step filters out synthetic samples that do not meet the required criteria for training. The filtering helps maintain quality control over the training data by ensuring valid, synthetic, code-switched samples are used to train the speech recognition model. The process examines each synthetic, code-switched audio sample generated through the combination of monolingual audio samples from different languages. Samples that pass the constraint verification become part of the training dataset, while samples that fail are excluded. The constraint checking helps ensure the model receives high-quality training data that properly represents code-switching scenarios between the first and second languages.

One or more embodiments train a speech recognition model 114 using monolingual audio samples to create synthetic, code-switched training data. The training process actively selects subsets of audio samples from two different languages (like Hindi and English) and combines them to generate synthetic, code-switched audio that includes both languages. During training, the process evaluates the generated, synthetic, code-switched audio samples against training constraints. For example, the process checks duration and token constraints to ensure seamless, transfer-based, ASR model fine-tuning. The synthetic, code-switched audio samples that satisfy these training constraints are used to train the speech recognition model 114. This on-the-fly, code-switch simulation approach addresses the challenge of limited, code-switched training data by leveraging existing monolingual audio to create diverse, code-switch points during model training. The speech recognition model 114 learns to handle language transitions through exposure to these synthetic, code-switched samples that meet the required training criteria.

One or more embodiments perform on-the-fly, code-switch simulation during training of a speech recognition model using monolingual audio samples. The system receives two sets of audio samples—one set in a first language (such as Hindi) and another set in a second language (such as English). During the training process, the system selects subsets of audio samples from each language to create synthetic, code-switched training data.

The system generates synthetic, code-switched audio samples by combining segments from the selected subsets of the first and second languages. Each synthetic sample includes audio content that switches between both languages, simulating natural, code-switching behavior. This approach addresses the scarcity of real, code-switched training data by artificially creating diverse examples of language switching points.

The system then evaluates the generated synthetic samples against training constraints, such as duration limits and token requirements needed for effective model training. The system separates the synthetic samples into two groups—those that satisfy training constraints and those that do not. The speech recognition model is then trained using the synthetic samples that meet the required constraints.

This process exposes the model to a variety of code-switching patterns during training while ensuring the training data meets quality standards. The approach allows the model to learn to handle transitions between languages without requiring large amounts of naturally occurring, code-switched speech data. By generating synthetic training examples on-the-fly, one or more embodiments provide a practical solution for training speech recognition models to handle code-switching in low-resource scenarios.

### 2.1 Duration Threshold Check

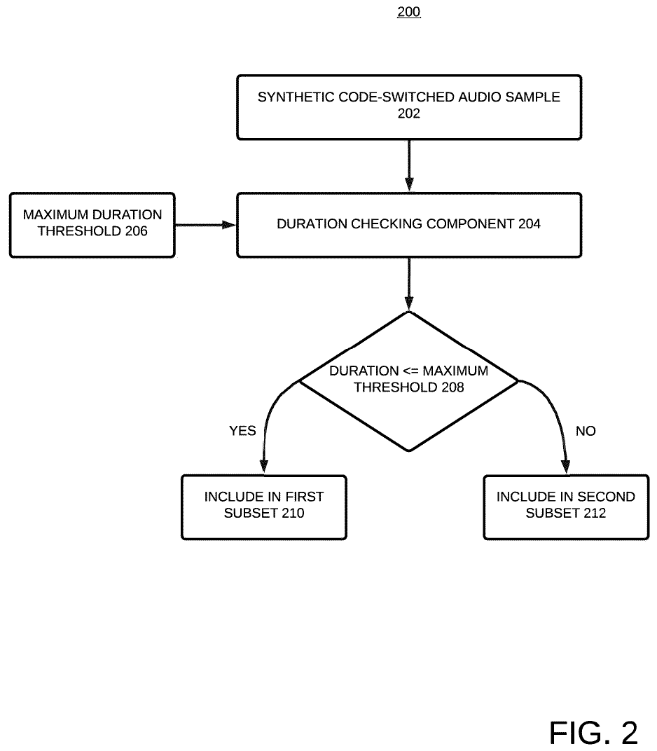

FIG. 2 illustrates a system 200 for evaluating synthetic, code-switched audio samples against a maximum duration threshold and sorting them into subsets based on threshold compliance according to one or more embodiments.

One or more embodiments evaluate synthetic, code-switched audio samples against a maximum duration threshold as part of determining training constraints. After generating synthetic, code-switched audio samples by combining audio content from a first language and a second language (Operation 202), the embodiments check the duration of each synthetic sample (Operation 204). The embodiments verify that a synthetic, code-switched audio sample included in the first subset used for training has a duration that falls within acceptable bounds by not exceeding the maximum duration threshold 206. This duration check helps ensure the training data remains practical and consistent for effectively training the speech recognition model. By enforcing a maximum duration constraint, the embodiments prevent excessively long synthetic samples that could negatively impact the training process or model performance.

One or more embodiments generate a synthetic, code-switched audio sample 202 and verify the synthetic, code-switched audio sample stays within a maximum duration threshold. This threshold constrains training to ensure audio samples remain within acceptable length limits (e.g., 30 seconds) for the speech recognition model's input requirements. By filtering out overly long samples that could impair training, one or more embodiments ensure effective processing during both training and inference phases.

One or more embodiments include a duration checking component 204 that verifies synthetic, code-switched audio samples remain within a maximum duration threshold during training. The duration checking component evaluates combined audio segments from different language subsets and filters out samples exceeding the threshold, placing them in a second subset. This validation maintains training data consistency and ensures compatibility with speech recognition model architecture input length limitations.

One or more embodiments validate synthetic, code-switched audio samples using a maximum duration threshold value 206 during training. The system accepts samples below the maximum duration threshold value for training the speech recognition model and rejects those exceeding the maximum duration threshold value. This validation ensures audio samples remain within practical processing limits and maintain consistent, manageable lengths throughout training.

One or more embodiments evaluate synthetic, code-switched audio samples against a maximum duration threshold during training. A duration check 208 determines if each sample's duration stays within an acceptable time limit. Samples exceeding the threshold are placed in a second subset 212 that fails to meet training constraints, while samples within the limit are added to the first training subset 210. The duration constraint aligns with transformer-based, ASR models' typical, 30-second processing limit for audio segments.

One or more embodiments determine if synthetic, code-switched audio samples meet duration constraints during model training. Specifically, when combining audio samples from different languages to create synthetic, code-switched speech, the system checks that each combined sample does not exceed a maximum allowed duration threshold. This duration check helps ensure the synthetic samples remain within practical limits for processing by the speech recognition model. For example, since the underlying ASR model can process up to 30-second audio segments, the system verifies that concatenated samples stay within this time constraint. By enforcing maximum duration thresholds, one or more embodiments maintain synthetic training data that is compatible with the model architecture and training process requirements. Samples that exceed the duration threshold are filtered out and not used for training, while samples within the duration threshold are retained as valid training examples. This duration-based filtering helps create a clean, properly formatted synthetic dataset for effectively training the code-switching, speech recognition capabilities.

### 2.2 Speaker Matching

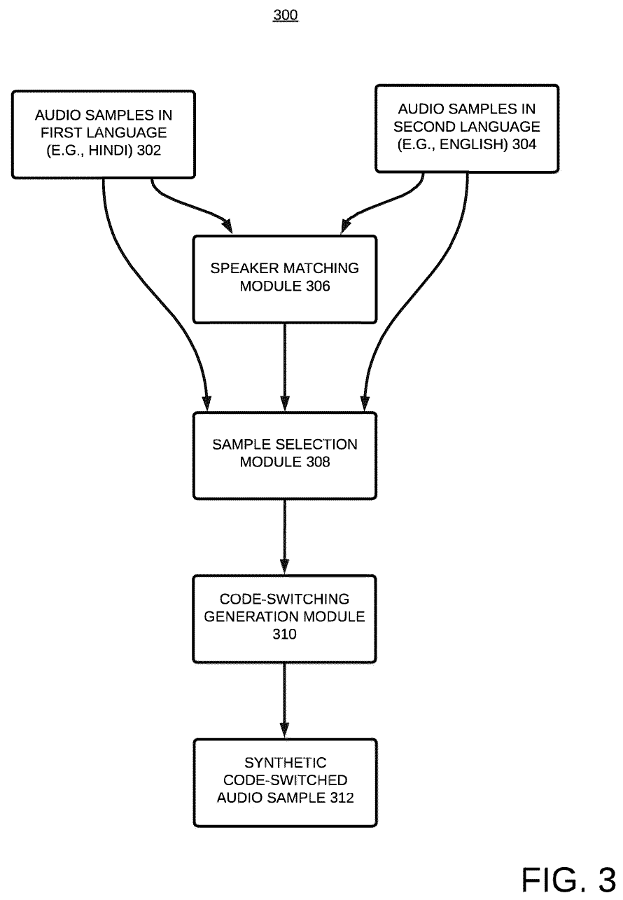

FIG. 3 illustrates a system 300 for generating synthetic, code-switched audio samples by matching and combining audio samples from the same speaker across different languages according to one or more embodiments.

One or more embodiments generate synthetic, code-switched audio samples by selecting audio samples from the same speaker across different languages. When selecting samples from the first and second languages, the system identifies a first audio sample from the first language and a second audio sample from the second language that are both associated with the same speaker. The system then combines these speaker-matched samples to create a synthetic, code-switched audio sample that includes audio content from both languages while maintaining speaker consistency. This speaker-matching approach helps ensure the naturalness and consistency of the generated, code-switched audio by using voice characteristics from a single speaker across the language transitions. The resulting synthetic, code-switched audio sample becomes part of the larger set of synthetic, code-switched samples used in the training process, where the synthetic, code-switched audio sample may be evaluated against training constraints and potentially used to train the speech recognition model if the synthetic, code-switched audio sample meets those constraints. This speaker-consistent approach enhances the quality and authenticity of the synthetic training data by preserving the speaker's unique vocal characteristics across both languages in the code-switched output.

One or more embodiments store audio samples in a first language 302 and associated speaker identity information in a first data storage. When generating synthetic, code-switched audio samples, these embodiments query the first data storage to select audio samples from matching speakers across different languages. This selection process maintains speaker consistency and preserves natural speaking characteristics when combining audio segments into synthetic, code-switched samples.

One or more embodiments store audio samples in a second language 304 organized by speaker identity in a second data storage. When generating synthetic, code-switched audio, the second data storage enables selection of audio samples from the same speaker in different languages by maintaining mappings between samples and speaker identities. The second data storage allows retrieval of a first audio sample in one language and a second audio sample in another language from the same speaker, maintaining speaker consistency in the generated, synthetic, code-switched audio.

One or more embodiments include a speaker matching module 306 that matches audio samples across languages by analyzing first and second pluralities of audio samples to identify those from the same speaker. When generating synthetic, code-switched audio, the speaker matching module selects matching first and second language samples from the same speaker to ensure consistency and maintain speaker continuity across language transitions. This enables natural-sounding, synthetic, code-switched samples for training speech recognition models.

One or more embodiments include a selection module 308 that selects audio samples from different languages while maintaining speaker consistency. The selection module analyzes speaker metadata to identify matching speakers between first and second language audio samples. When generating synthetic, code-switched audio, the selection module selects samples where the same speaker appears in both language samples. This speaker-aware selection creates natural-sounding, synthetic code-switched audio by maintaining consistent speaker characteristics across language transitions, supporting training of speech recognition models that handle code-switching between languages.

One or more embodiments include a code-switching generation module 310 that selects and combines audio samples from different languages while maintaining speaker consistency. The code-switching generation module analyzes speaker metadata to match speakers across first and second language samples, selects samples from the same speaker in each language, and combines them to create synthetic, code-switched audio with natural speaker characteristics during language transitions. This speaker-aware process produces more natural-sounding, code-switched audio for training speech recognition models.

One or more embodiments generate a synthetic, code-switched audio sample 312 by combining two audio samples from the same speaker in different languages. The embodiments select audio samples from collections in a first and second language, verify the audio samples are from the same speaker, and combine the audio samples to create code-switched speech. This process maintains speaker consistency across language transitions and produces realistic training data for speech recognition models handling code-switching patterns.

One or more embodiments generate synthetic, code-switched audio samples while maintaining speaker consistency across language transitions. The system selects audio samples from two different languages that come from the same speaker. For example, when creating a Hindi-English code-switched sample, the system identifies a Hindi audio segment and an English audio segment spoken by the same person. This speaker matching helps ensure natural-sounding transitions between languages in the synthetic audio.

The system then combines the selected, same-speaker audio samples to create a synthetic, code-switched recording. By using audio from the same speaker, one or more embodiments avoid jarring voice changes that could occur when concatenating samples from different speakers. This approach helps maintain the naturalness and quality of the synthetic training data.

This speaker-matching technique supports the broader goal of generating realistic, code-switched audio for training speech recognition models. The synthetic samples better reflect real-world, code-switching scenarios where a single speaker smoothly transitions between languages. By maintaining speaker consistency, one or more embodiments create more effective training data for improving the model's ability to handle code-switched, speech recognition tasks.

### 2.3 Audio-Sample Code-Switch Selection

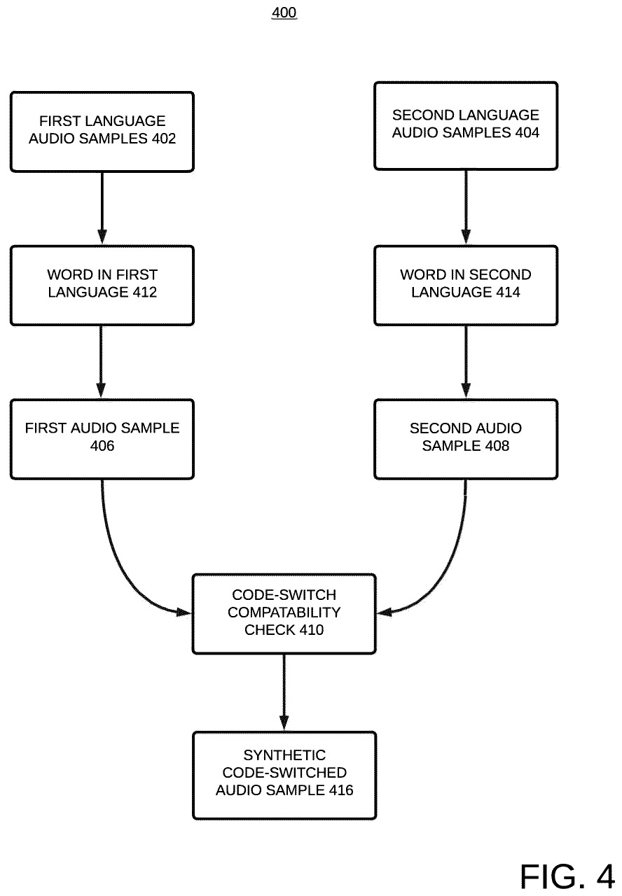

FIG. 4 illustrates a system 400 for selecting and combining language-specific audio samples based on code-switch compatibility between words to generate synthetic code-switched audio according to one or more embodiments.

One or more embodiments select specific audio samples from different languages to create synthetic, code-switched audio based on code-switching compatibility. The system analyzes a first audio sample that includes speech in a first language and a second audio sample that includes speech in a second language. The system determines if a word spoken in the first audio sample can appropriately code-switch with a word spoken in the second audio sample. When the system identifies such compatible words, the system selects those audio samples for combination. The system then generates a synthetic, code-switched audio sample by combining the selected first and second audio samples that include the compatible words. This code-switched audio sample becomes part of the larger set of synthetic, code-switched samples used to train the speech recognition model. This approach ensures that the generated, code-switched audio includes natural and linguistically appropriate transitions between the two languages, improving the quality of the training data used to develop the speech recognition model's ability to handle code-switching scenarios.

One or more embodiments use first language audio samples 402 to provide source material for generating synthetic, code-switched speech. These samples include words that can naturally combine with words from a second language to create realistic, code-switching patterns. When words from both languages are determined to be compatible for code-switching, the system combines them to generate synthetic, code-switched audio samples. This process creates training data that helps speech recognition models learn to handle code-switched speech effectively.

One or more embodiments utilize second language audio samples 404 that include speech in a second language different from the first language. The system selects samples from both languages to create synthetic, code-switched audio with natural transitions. When selecting second language samples, the system evaluates if words can form valid, code-switch combinations with first language words. This evaluation ensures natural and linguistically appropriate code-switching patterns. The system combines the selected samples to satisfy training constraints for speech recognition model training, enabling creation of realistic, code-switched training data despite limited, natural, code-switched speech data.

One or more embodiments select a first audio sample 406 from audio samples in a first language for generating synthetic, code-switched speech. The sample includes spoken content that will be evaluated for code-switch compatibility with content from a second language sample. The selection process examines if words from both samples can naturally combine to create valid, code-switching points. This compatibility check ensures natural language transitions in the resulting synthetic code-switched audio. The first audio sample 406 helps construct synthetic training data to expose the speech recognition model to diverse code-switch scenarios.

One or more embodiments select a second audio sample 408 in a second language to pair with a first audio sample in a first language when generating synthetic, code-switched audio. The selection process verifies code-switch compatibility between words in the samples to ensure natural language transitions. After confirming compatibility, the embodiments combine the samples to create synthetic, code-switched audio for training speech recognition models.

One or more embodiments perform a code-switch compatibility check 410 to evaluate if words from different languages can naturally transition and combine when generating synthetic, code-switched audio samples. The code-switch compatibility check verifies natural transitions between words in different languages, such as from Hindi to English, while avoiding combinations of direct translations or unnatural language transitions. The code-switch compatibility check helps generate high-quality, synthetic, code-switched audio samples that reflect authentic, code-switching patterns found in natural speech, supporting improved ASR performance on code-switched speech where limited training data exists.

One or more embodiments identify and select a word 412 from the first audio sample 406 that can naturally combine with a word 414 from the second audio sample 408 in a different language to create a code-switching point. The system determines if words are code-switch compatible by checking if the words can naturally transition between languages based on typical code-switching patterns. For example, in Hindi-English code-switching, the system identifies Hindi words that commonly appear adjacent to English words in natural speech. This compatibility check helps maintain natural language flow and avoids jarring transitions when generating, synthetic code-switched training data for improving automatic speech recognition of code-switched speech.

One or more embodiments identify a word 414 in the second language to determine code-switch compatibility between words from different languages when generating synthetic, code-switched audio samples. The word in the second language represents a word from the second language audio sample 408 evaluated for compatibility with the first language word 412. The compatibility check ensures natural, code-switching patterns, such as when combining Hindi and English audio samples. The word in the second language enables selection of compatible audio sample pairs that produce realistic, code-switched speech when combined, improving synthetic training data quality for speech recognition models.

One or more embodiments generate synthetic, code-switched audio by combining compatible audio samples from different languages. The process checks if words from a first language can naturally transition to words in a second language at code-switch points, filtering out unnatural combinations, like direct translations or incompatible word pairings. For example, with Hindi-English code switching, the system verifies that Hindi words flow naturally into English words. After confirming compatibility, the process combines the audio samples to create synthetic speech including natural transitions between both languages, producing realistic training data that represents natural code-switching patterns.

One or more embodiments select audio samples for code-switching based on the compatibility of words at potential code-switch points. The system analyzes words spoken in a first audio sample in a first language and words spoken in a second audio sample in a second language to determine if the words can form natural code-switch transitions. When compatible words are identified, the system selects those specific audio samples for generating synthetic code-switched training data.

For example, in Hindi-English code-switching, the system may identify that a Hindi word for “document” pairs naturally with the English word “formatting” based on common code-switching patterns. The system would then select audio samples including these compatible word pairs to create synthetic, code-switched audio that mimics natural language transitions. This selective pairing helps ensure the generated training data includes realistic code-switch points rather than arbitrary combinations.

The compatibility assessment allows the system to avoid generating synthetic data with awkward or unnatural language transitions that could degrade model training. By focusing on word pairs that commonly occur together in real, code-switched speech, the system produces higher quality, synthetic training samples that better represent actual, code-switching behavior. This targeted selection process improves the effectiveness of the synthetic data for training speech recognition models to handle code-switched speech.

### 2.4 Code-Switched Audio Generation

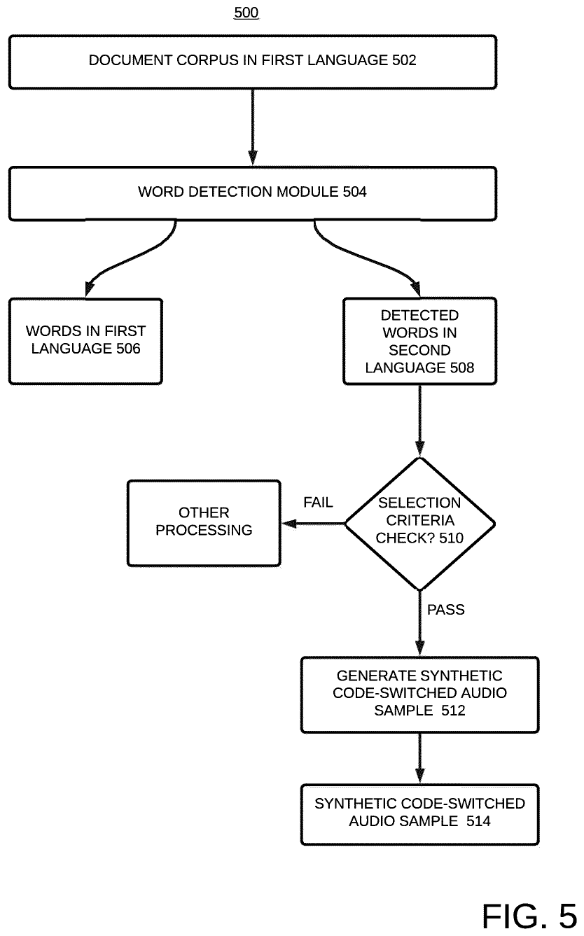

FIG. 5 illustrates a system 500 for generating synthetic, code-switched audio samples by analyzing a document corpus and detecting second language words that meet selection criteria according to one or more embodiments.

One or more embodiments identify patterns of natural code-switching by analyzing a document corpus primarily written in a first language. The system searches for and detects instances where words from a second language appear within the predominantly first-language text. The system evaluates these detected, second-language word occurrences against defined selection criteria to determine if the second-language word occurrences represent natural code-switching patterns.

When the occurrences of second-language words meet the selection criteria, the system generates synthetic, code-switched audio samples that incorporate these validated code-switching patterns. Each synthetic sample combines speech of the identified second-language word with speech of surrounding first-language words. This approach ensures the generated, code-switched audio samples reflect realistic language mixing patterns observed in the analyzed document corpus.

This document corpus analysis and pattern-based generation process works in conjunction with the broader training methodology. The system uses these naturally derived, code-switched patterns to inform how the system combines the selected first-language and second-language audio subsets when generating the synthetic training samples. This helps produce more authentic-sounding, code-switched audio that better represents real-world speech patterns, ultimately improving the quality of samples used to train the speech recognition model.

One or more embodiments create synthetic, code-switched training data from a document corpus 502 that includes text primarily in a first language with occasional words from a second language. The system identifies second language words within first language contexts that meet selection criteria, like frequency thresholds or contextual relevance. Using these instances as templates, the system generates synthetic audio samples that combine speech of the second language words with speech of surrounding first language words. This approach leverages authentic, code-switching patterns to create training data reflecting natural language switching behaviors, helping address the scarcity of code-switched training data.

One or more embodiments implement a word detection module 504 that analyzes document corpora to identify code-switching patterns. The word detection module 504 scans a first-language corpus to detect second-language words and evaluates these occurrences against selection criteria. When word combinations meet the criteria thresholds, the word detection module 504 flags them for synthetic audio generation. This enables creation of realistic code-switched speech samples based on natural language mixing patterns from real text data. For example, when analyzing a Hindi corpus, the word detection module 504 may detect frequently occurring English technical terms and use these as templates for generating synthetic, code-switched audio that authentically combines both languages.

One or more embodiments identify words in a first language 506 from a first document corpus as part of generating synthetic, code-switched audio samples. The process analyzes the corpus to find second language words within predominantly first-language text. When second language words meet selection criteria, one or more embodiments combine their speech with first language word speech to create synthetic, code-switched audio samples. This approach leverages natural, code-switching patterns from existing documents to generate realistic, code-switched speech data while maintaining authentic, code-switching behavior. The synthetic samples help train speech recognition models to handle real-world, code-switching between the first and second languages.

One or more embodiments detect words in a second language 508 by identifying their occurrences within a document corpus primarily including text in a first language. Upon finding words that meet specified selection criteria, the embodiments create synthetic, code-switched audio by combining speech of the detected second language words with first language speech. This process helps generate synthetic, code-switched audio samples that reflect natural language mixing patterns, supporting the development of code-switched, speech recognition systems when authentic training data is limited.

One or more embodiments use a selection criteria check 510 to evaluate words from one language appearing within text primarily written in another language. The selection criteria check 510 verifies that detected language mixing instances meet specific requirements before generating synthetic, code-switched audio, ensuring natural language mixing patterns. For example, when examining Hindi documents, the selection criteria check 510 evaluates English words within Hindi text to verify genuine code-switching rather than simple translations. The selection criteria check 510 filters out improper combinations and ensures meaningful Hindi-English elements, serving as quality control for authentic, synthetic, training data generation for speech recognition models.

One or more embodiments generate synthetic, code-switched audio samples 512 by analyzing document corpora to identify code-switching opportunities. The process identifies Hindi documents including English words, evaluates these English words against selection criteria for natural, code-switching points, and generates audio samples combining English and Hindi speech at valid switch points. This creates realistic training data reflecting natural language mixing patterns for improving speech recognition of code-switched content.

One or more embodiments generate synthetic, code-switched audio samples 514 by analyzing documents that include primarily first-language words (e.g., Hindi) to detect natural occurrences of second-language words (e.g., English). After evaluating detected, second-language words against selection criteria to validate code-switching patterns, the embodiments generate audio samples combining speech of validated, second-language words with speech of surrounding, first-language words. For example, if the English word “document” frequently appears in Hindi text, the embodiments generate synthetic audio combining the English word's pronunciation with Hindi words to create natural-sounding, code-switched utterances that reflect authentic language mixing patterns.

One or more embodiments enhance code-switched speech recognition by leveraging document analysis to generate realistic, synthetic training data. The system analyzes a document corpus that is predominantly in a first language to identify naturally occurring instances where words from a second language appear. When the system detects second language words that meet certain selection criteria, the system uses these occurrences as templates for generating synthetic, code-switched audio samples.

For example, if analyzing a Hindi document corpus, the system may identify English technical terms that frequently appear within Hindi text. The system verifies these English terms meet specified selection criteria, such as frequency thresholds or semantic relevance. When valid instances are found, the system generates synthetic audio that combines speech of the English technical term with speech of the surrounding Hindi words.

This approach helps ensure the synthetic, code-switched samples reflect authentic language mixing patterns observed in real-world usage. Rather than randomly combining words from different languages, the system bases the system's synthetic data generation on documented examples of how speakers naturally incorporate words from one language into discourse in another language. The resulting synthetic audio provides more realistic training examples for improving the speech recognition model's handling of code-switching scenarios.

The synthetic samples generated through this targeted approach contribute to the broader training process, where the speech recognition model learns from synthetic, code-switched audio that satisfies training constraints. By grounding the synthetic data in language usage patterns found in text corpora, one or more embodiments create higher quality training examples that better represent real-world, code-switching behavior.

### 2.5 Text-to-Speech With Speaker Characteristics

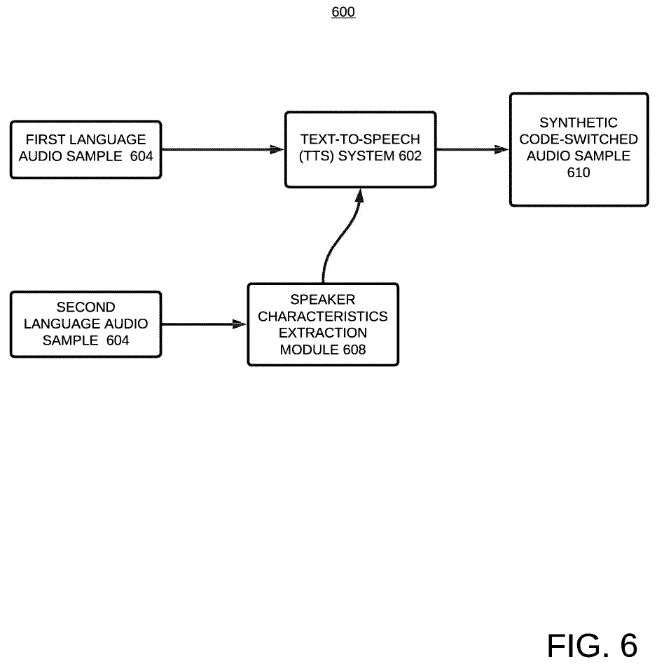

FIG. 6 illustrates a system 600 for generating synthetic, code-switched audio samples using a text-to-speech system while maintaining speaker characteristics from audio samples in different languages according to one or more embodiments.

One or more embodiments generate synthetic, code-switched audio samples by leveraging a text-to-speech (TTS) system to maintain speaker consistency across languages. The TTS system generates a first audio sample in the first language while preserving speaker characteristics from a second audio sample in the second language. This approach ensures that the synthetic output maintains the voice qualities, accent, pitch, and other identifying features of the original speaker even when producing speech in a different language. The system then combines the TTS-generated first audio sample with the second audio sample to create a synthetic, code-switched audio sample that includes both languages while maintaining natural-sounding speaker characteristics throughout. This technique enhances the training data generation process by creating more realistic code-switched samples that preserve speaker identity across language boundaries. The resulting synthetic, code-switched audio samples provide higher quality training data for the speech recognition model while maintaining speaker consistency; this is particularly important for handling real-world, code-switching scenarios where speakers naturally switch between languages while maintaining their distinct voice characteristics.

One or more embodiments use a text-to-speech (TTS) system 602 that generates synthetic audio while preserving speaker characteristics across languages. The TTS system accepts text in a first language and outputs audio that maintains speaker-specific voice qualities from an existing audio sample in a second language. For example, the TTS system can generate English audio content that matches voice qualities from an existing Hindi audio sample. This enables creation of natural-sounding, synthetic, code-switched audio samples with consistent voice characteristics across languages. The TTS system generates training data for speech recognition by producing code-switched audio that maintains speaker continuity during language switches, better representing natural multilingual speech patterns.

One or more embodiments generate a first audio sample 604 in a first language that preserves speaker characteristics from a second audio sample in a second language using text-to-speech (TTS). The TTS system creates synthetic code-switched training data by combining the generated first audio sample with the second audio sample, maintaining consistent speaker characteristics like pitch, timbre, and speaking style across language transitions. The synthetic training data improves automatic speech recognition (ASR) of code-switched speech between different languages.

One or more embodiments use a second audio sample 604 in a second language as a reference to maintain speaker characteristics when generating synthetic, code-switched audio via text-to-speech (TTS). The TTS system preserves the speaker's voice timbre, speaking style, and vocal attributes while generating a first audio sample in a first language. By maintaining consistent speaker characteristics across both language samples, the synthetic, code-switched audio combines the generated first audio sample with the second audio sample naturally, enabling better training of speech recognition models for code-switching scenarios.

One or more embodiments include a speaker characteristics extraction/maintenance module 608 that preserves speaker voice characteristics when generating synthetic, code-switched audio across different languages. The speaker characteristics extraction/maintenance module enables text-to-speech systems to generate audio in one language while matching speaker characteristics from an audio sample in another language, such as maintaining an English speaker's voice characteristics when generating Hindi audio. This creates natural-sounding synthetic training data that mimics bilingual speech patterns where speakers switch between languages while retaining their distinctive voice qualities.

One or more embodiments generate a synthetic, code-switched audio sample 610 by combining audio samples from different languages while preserving speaker characteristics. Specifically, the embodiments create a first audio sample in a first language that maintains the voice quality and speaking style from a second audio sample in a second language. For example, when given Hindi speech from a speaker, the system generates matching English speech with the same voice characteristics. The system combines these aligned samples to create natural-sounding, code-switched speech where the speaker's voice remains consistent across language transitions. This generated audio helps address the scarcity of real, code-switched speech data for training ASR systems.

One or more embodiments generate synthetic, code-switched audio samples while preserving speaker characteristics across language boundaries. A text-to-speech (TTS) system first generates an audio sample in a first language. The TTS system maintains specific speaker characteristics, such as voice quality, pitch, or speaking style, that match those of an existing speaker's audio sample in a second language. The system then combines the TTS-generated audio sample with the existing audio sample to create a synthetic, code-switched audio sample that includes both languages. This approach ensures consistency in speaker identity across the language transition points within the synthetic audio. For example, if the existing audio sample includes English speech from a female speaker with certain vocal characteristics, the TTS system generates Hindi speech that matches those same female vocal characteristics. The resulting synthetic, code-switched audio sample sounds natural and maintains speaker continuity as the synthetic, code-switched audio sample transitions between Hindi and English segments. This technique helps create more realistic training data for improving speech recognition models' ability to handle code-switching speech patterns.

### 3. Language Model-Based Synthetic Data Generation for Code-Switching Automatic Speech Recognition

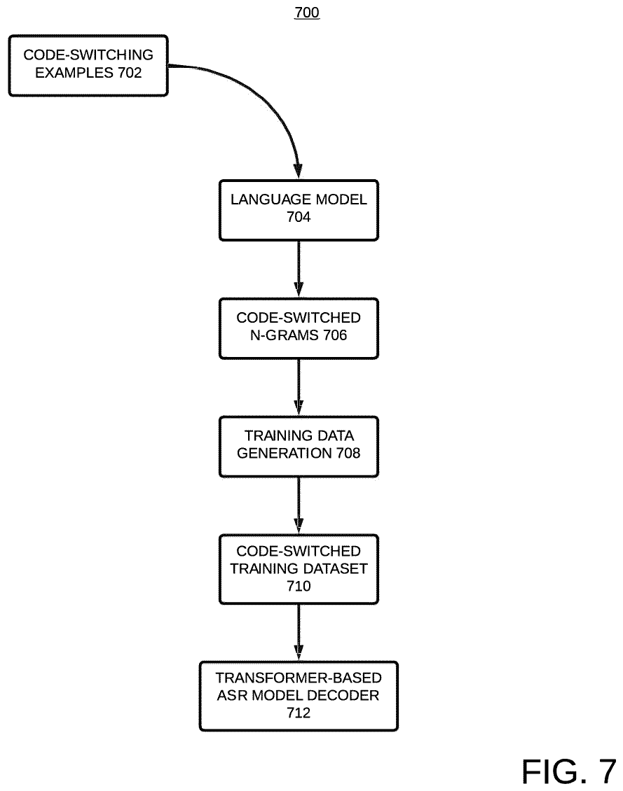

FIG. 7 illustrates a system 700 for improving code-switching capabilities in automatic speech recognition through language model training and decoder fine-tuning according to one or more embodiments.

One or more embodiments improve code-switching capabilities in automatic speech recognition (ASR) systems by leveraging a language model to generate training data. The process begins by providing the language model with examples of code-switching between two languages. These examples demonstrate how speakers naturally switch between the languages within conversations or sentences.

The language model analyzes these examples and produces code-switched N-grams. Each N-gram includes words from both languages, capturing natural language transitions that occur during code-switching. The language model generates these N-grams by learning patterns from the provided examples, identifying common and meaningful combinations of words across the two languages.

One or more embodiments then use the language model to create a comprehensive training dataset. This dataset comprises code-switched training sentences that incorporate the previously generated N-grams. The sentences serve as realistic examples of how speakers might combine both languages in natural speech.

The process concludes by fine-tuning the decoder portion of a transformer-based ASR model using the generated training dataset. The decoder learns to recognize and process speech that includes code-switching by training on the crafted sentences. This focused training enhances the ASR system's ability to accurately transcribe speech that alternates between the two languages.

One or more embodiments use examples 702 of code-switching between a first language and a second language to a language model. The examples 702 serve as a basis for feeding few-shot prompts to guide the language model in generating domain-specific, code-switched content. For example, when working with Hindi-English code-switching, the examples 702 encompass batches of five Hindi-English sentences from training data to the language model. These input examples help establish the context and pattern of code-switching that the language model should emulate and provide real, code-switched examples that demonstrate natural language transitions and domain-specific vocabulary usage. This approach enables the language model to better understand the target domain's code-switching patterns and generate appropriate, code-switched N-grams that reflect realistic language mixing behaviors.

The language model 704 represents a component in one or more embodiments that processes code-switching examples between two languages to generate synthetic training data. The language model 704 takes few-shot prompts including example code-switched sentences and generates code-switched bigrams. The language model 704 receives crafted prompts that specify the language model's role as a bilingual bigram generator capable of handling both languages (for example, Hindi and English). The language model 704 analyzes the provided examples to understand the code-switching patterns and generates new bigrams that maintain natural language transitions between the two languages. One or more embodiments use language model 704 to generate thousands of unique, code-switched bigrams that capture authentic language mixing patterns found in the target domain. The language model 704 ensures the generated bigrams avoid direct translations between languages and include legitimate words from both languages. This automated generation process through the language model 704 helps address the scarcity of code-switched training data by creating synthetic but domain-appropriate examples for training ASR systems.

One or more embodiments generate code-switched N-grams 706 through language model 704 that receives example code-switched sentences 702 as input. The language model 704 uses these examples 702 in a few-shot prompting approach to generate domain-specific, synthetic, code-switched bigrams 706. For instance, when given several Hindi-English mixed sentences as examples 702, the language model 704 generates batches of code-switched, bigram pairs 706 including one Hindi word and one English word. The language model 704 enforces constraints to ensure each bigram includes words from both languages rather than direct translations. This process produces tens of thousands of initial, code-switched bigrams in one implementation. After filtering for uniqueness and validity, thousands of high-quality bigrams remain that properly represent code-switching between the two languages. The code-switched N-grams 706 are used as building blocks for generating more complex code-switched training sentences. This systematic approach allows controlled generation of code-switched content while maintaining linguistic accuracy and domain relevance.

The training dataset generation 708 represents a component in one or more embodiments that generate training data for improving code-switching capabilities in ASR systems. This generation 708 implements a two-stage process for creating synthetic training data. In the first stage, the training dataset generation 708 leverages language model 704 to generate code-switched N-grams 706 by providing example code-switched sentences 702 as few-shot prompts. The language model 704 processes these examples 702 to produce bigrams 706 that include one word in each language, ensuring the words are not mere translations of each other. In the second stage, the generation 708 uses the validated N-grams to prompt the language model 704 to generate complete code-switched training sentences. The language model 704 generates multiple sentences for each valid N-gram, incorporating the code-switched patterns naturally into both languages. The generation 708 ensures the generated sentences maintain the target domain characteristics by using in-domain examples as prompts. This process creates a training dataset that helps the transformer-based ASR model learn to handle language transitions effectively at code-switch points. The training dataset generation 708 therefore serves as a bridge between example code-switched inputs and the creation of comprehensive training data needed for fine-tuning the ASR model's decoder.

The training dataset 710 represents a component in one or more embodiments where the language model 704 generates training data for improving code-switching capabilities in ASR systems. The training dataset 710 comprises code-switched N-grams that the language model 704 generates based on provided examples 702. These N-grams include words from both languages, ensuring authentic representation of language mixing patterns. For instance, in Hindi-English code-switching, one or more embodiments generate bigrams where one word is in Hindi (Devanagari script) and another in English (Latin script). The training dataset 710 serves as input for fine-tuning the decoder portion of a transformer-based ASR model, enabling the ASR model to better handle code-switched speech. The dataset creation process aligns with using few-shot prompting with the language model 704 to generate domain-specific, code-switched utterances that match target domain characteristics.

The transformer-based ASR model 712 represents a neural network architecture that processes speech input to generate text output. One or more embodiments use this model as the foundation for improving code-switching speech recognition capabilities. The model specifically employs an encoder-decoder architecture with a billion or more parameters and uses a sequence-to-sequence approach to process log-Mel spectrograms of speech input. The transformer-based ASR model takes audio segments up to 30 seconds in length and chunks longer inputs into appropriate segments for processing.

One or more embodiments fine-tune this model using synthetically generated, code-switched training data. The model processes the training data through the model's encoder-decoder architecture with specific focus on adapting the decoder portion to better handle transitions between languages. The model incorporates language tokens like <|en|> and <|hi|> to help guide the model's processing of different languages during both training and inference.

The transformer-based ASR model serves as the core component that learns to recognize and transcribe speech, including code-switching between languages, like Hindi and English. Through fine-tuning with the synthetic training data generated via language model prompting, one or more embodiments improve the model's ability to handle seamless transitions between languages in speech input.

One or more embodiments improve code-switching capabilities of an ASR system by using a language model to generate synthetic training data. The language model first receives example sentences that include code-switching between two languages, such as Hindi and English. Using these examples as guidance through few-shot prompting, the language model generates code-switched bigrams where each bigram includes one word in the first language and one word in the second language.

One or more embodiments then use the language model to create training sentences that naturally incorporate the generated, code-switched bigrams. For each valid bigram, the language model generates multiple sentences-some with the first language as the primary language and others with the second language as the primary language. This creates a diverse training dataset that exposes the ASR model to various code-switching patterns and contexts.

One or more embodiments then use this synthetic training dataset to fine-tune the decoder portion of a transformer-based ASR model. The fine-tuning process helps the ASR model learn to better handle transitions between languages at code-switch points. By training on synthetically generated code-switched sentences, the ASR model can improve the ASR model's ability to recognize and transcribe speech that includes natural language switching even when limited real code-switched training data is available.

### 3.1 Transformer-Based ASR Fine-Tuning

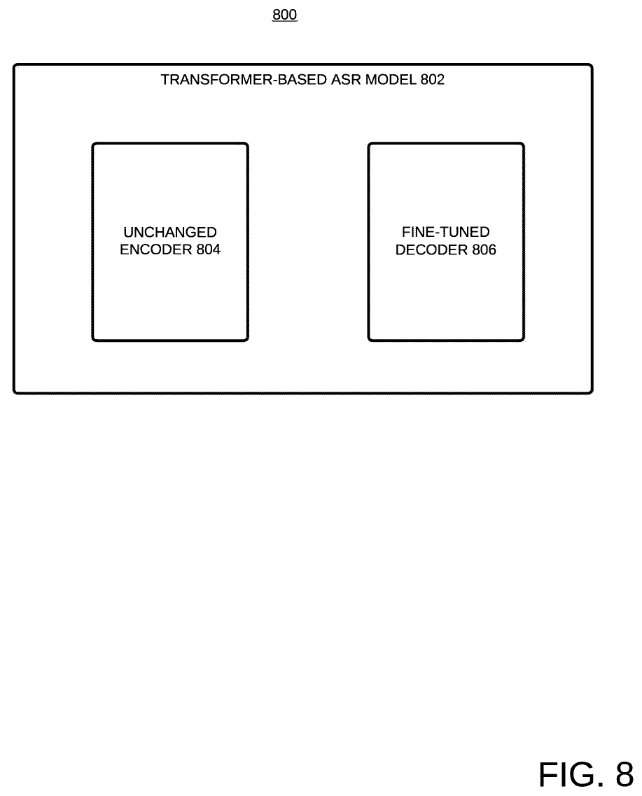

FIG. 8 illustrates a system 800 for fine-tuning a decoder portion of a transformer-based ASR model while maintaining an unchanged encoder portion during code-switching adaptation, according to one or more embodiments.

One One or more embodiments fine-tune the decoder portion of a transformer-based ASR model while deliberately keeping the encoder portion unchanged during the fine-tuning process. This approach preserves the acoustic modeling capabilities of the encoder while adapting the language modeling capabilities of the decoder to handle code-switched speech. The fine-tuning process uses the training dataset that includes code-switched training sentences incorporating N-grams generated by the language model based on examples of code-switching between two languages. By maintaining the encoder portion unchanged, one or more embodiments ensure that the model retains the model's ability to process acoustic features effectively while improving the model's ability to recognize and transcribe speech that switches between different languages.

One or more embodiments fine-tune a transformer-based ASR model 802's decoder portion while maintaining the transformer-based ASR model 802's encoder portion unchanged. Keeping the encoder fixed while updating the decoder preserves speech recognition capabilities while adapting language generation for code-switched speech between languages, like Hindi and English.

One or more embodiments maintain an unchanged encoder portion 804 of the transformer-based ASR model during decoder fine-tuning. The encoder 804 processes audio features into encoded representations while preserving the encoder's pre-trained acoustic feature extraction capabilities. By keeping the encoder 804's original weights and architecture fixed, the fine-tuning focuses on improving the decoder's handling of code-switched language transitions using synthetic training data.

One or more embodiments fine-tune a decoder portion 806 of a transformer-based ASR model while keeping the encoder portion fixed. The decoder 806 processes encoded representations to generate text output and learns to handle code-switched speech between two languages, like Hindi and English. The decoder learns language transitions at code-switch points using training data including code-switched sentences generated from N-grams that combine words from both languages. This approach improves code-switching capabilities while maintaining computational efficiency and base speech recognition abilities.

One or more embodiments maintain an encoder portion of a transformer-based ASR model unchanged during fine-tuning by keeping the encoder portion frozen. This preserves the pre-trained encoder's learned features while allowing the decoder portion to adapt specifically to code-switching challenges between languages, like Hindi and English. The approach prevents catastrophic forgetting of pre-trained encoder features while enabling targeted improvements through decoder adaptation.

One or more embodiments fine-tune a transformer-based ASR model's decoder while maintaining the encoder unchanged. The fine-tuning improves the decoder's handling of code-switched speech between two languages, like Hindi and English. Training data that includes code-switched sentences adjusts model parameters. An language model generates these training sentences using example code-switching inputs and specially crafted N-grams combining words from both languages. This selective updating preserves the encoder's learned features while enhancing the decoder's code-switching transcription capabilities.

In one or more embodiments, fine-tuning updates the decoder portion of the transformer-based ASR model while keeping the encoder portion fixed. Training affects the decoder components, preserving the encoder's acoustic feature extraction while enhancing code-switching capabilities through decoder adaptation using code-switched training sentences generated from language model-produced N-grams.

One or more embodiments improve code-switching ASR capabilities by selectively fine-tuning the decoder portion of a transformer-based ASR model while keeping the encoder portion unchanged. This targeted, fine-tuning approach maintains the encoder's learned feature extraction capabilities while adapting the decoder's language modeling abilities to handle code-switched speech. The encoder portion continues to process the input audio features and extract relevant acoustic information in the same way the encoder portion was originally trained. Meanwhile, the decoder portion learns to better handle the language transitions and vocabulary specific to code-switching scenarios through exposure to the synthetic training data generated using code-switched N-grams. This selective, fine-tuning strategy helps prevent catastrophic forgetting of the model's original capabilities while incorporating new code-switching knowledge. The approach is particularly useful when working with limited training data, for the approach reduces the number of parameters that need to be updated during the fine-tuning process.

### 3.2 Decoder Fine-Tuning

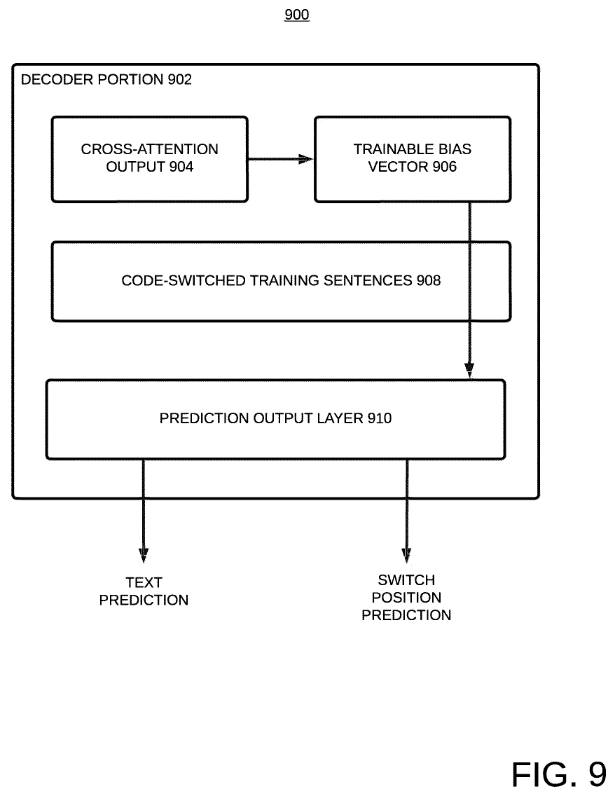

FIG. 9 illustrates a system 900 for fine-tuning a decoder portion by replacing cross-attention output with a trainable bias vector and predicting language switch positions using language tokens according to one or more embodiments.

One or more embodiments fine-tune the decoder portion of a transformer-based ASR model by implementing modifications to handle code-switching detection and transcription. The fine-tuning process replaces the cross-attention output in the decoder portion with a trainable bias vector. This modification allows the decoder to learn language-switching patterns independently of the encoder's output. The process then inserts special language tokens into the code-switched training sentences at positions where language switches occur between the first and second languages. These language tokens serve as explicit markers for the boundaries between different languages in the speech input. The decoder portion undergoes training to simultaneously accomplish two tasks, predicting the transcribed text and identifying the positions where language switches occur. This dual-task training utilizes both the inserted language tokens and the trainable bias vector to help the model learn the patterns and structure of code-switched speech. The combination of the bias vector and language tokens enables the decoder to develop a more nuanced understanding of code-switching patterns while maintaining accurate transcription capabilities.

One or more embodiments modify a decoder portion 902 of a transformer-based ASR model by replacing cross-attention output 904 with a trainable bias vector 906 and adding language tokens at code-switching points. The modified decoder processes training sentences that include special tokens marking Hindi-English transitions, enabling simultaneous prediction of transcribed text and language switch locations. The trainable bias vector helps learn language-specific patterns, while the language tokens mark speech transitions between languages, allowing seamless handling of code-switching scenarios.

One or more embodiments replace a cross-attention output 904 in a transformer-based ASR decoder with a trainable bias vector 906 during code-switching fine-tuning. The trainable bias vector works with language tokens inserted at code-switch points to help the decoder predict transcribed text and language switch locations between language pairs. This combination enables better handling of language transitions and more effective processing of code-switched speech during inference.

One or more embodiments enhance code-switching speech recognition by using a trainable bias vector 906 in the decoder that replaces cross-attention output 904. The trainable bias vector 906 works with language tokens inserted at switch points in code-switched training sentences, enabling simultaneous prediction of transcribed text and language switch locations. During fine-tuning with Hindi-English code-switched data, the trainable bias vector 906 adapts to language transition patterns while maintaining computational efficiency by avoiding cross-attention calculations.

One or more embodiments train a decoder portion 902 of a transformer-based ASR model using code-switched training sentences 908 that include N-grams with words from two different languages. The decoder replaces cross-attention output 904 with a trainable bias vector 906 and processes language tokens inserted at language switch points. This allows the decoder 902 to predict both transcribed text and language switch locations, improving the decoder 902's handling of mixed-language speech input.

One or more embodiments include a prediction output layer 910 that enables simultaneous prediction of transcribed text and language switch positions in code-switched speech. The prediction output layer works with a trainable bias vector 906, replacing cross-attention output 904 in the decoder to learn language switching patterns. The prediction output layer 910 processes language tokens inserted at switch points in training sentences, along with the bias vector 906, to generate transcriptions and identify language transitions. Through fine-tuning on natural and synthetic code-switched training data, the prediction output layer 910 learns to recognize language switch patterns between languages, like Hindi and English.

One or more embodiments improve decoder fine-tuning in a transformer-based ASR system by implementing specific techniques to handle language switching points. The decoder portion undergoes modifications where the decoder portion's cross-attention output is replaced with a trainable bias vector that can learn language transition patterns. The system inserts special language tokens into the training sentences at positions where the speech switches between languages, such as from Hindi to English or English to Hindi. These language tokens act as explicit markers that help the model identify and learn the boundary points between different languages. During training, the decoder learns to jointly predict both the actual transcribed text as well as the positions where language switches occur by leveraging the inserted language tokens and the trainable bias vector. This joint prediction approach helps the model develop a more nuanced understanding of code-switching patterns. The trainable bias vector allows the decoder to learn language-specific characteristics while the explicit language tokens provide clear signals about transition points. This combined approach enables the decoder to better handle the seamless transitions that occur in natural, code-switched speech.

### 3.3 Code-Switched Bi-Gram Generation

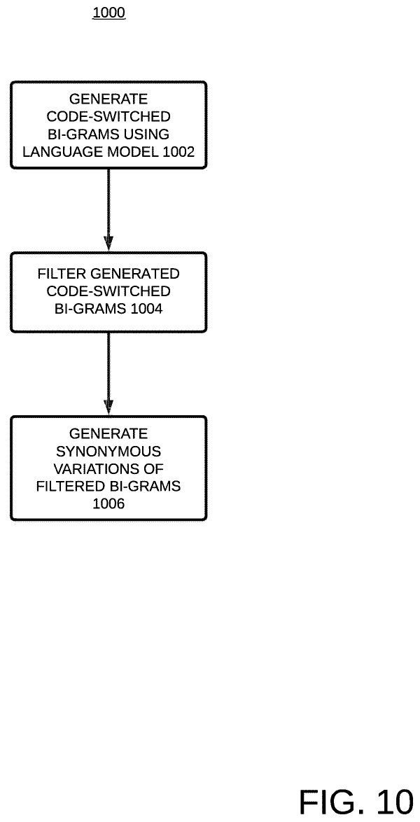

FIG. 10 illustrates a system 1000 for generating code-switched training sentences through language model bi-gram generation, filtering, and synonymous variation creation according to one or more embodiments.

One or more embodiments generate code-switched training sentences through a multi-step process that builds upon the initial code-switched N-grams. The process begins by using a language model to specifically generate code-switched bi-grams. These are pairs of words where one word is from the first language and the other word is from the second language. The system then applies filtering criteria to these bi-grams to produce a refined set that meets desired quality or relevance thresholds. After filtering, the system creates additional training variety by generating synonymous variations of the filtered bi-grams. These variations maintain the code-switching pattern while introducing lexical diversity into the training data. The system incorporates these processed bi-grams and their variations into the larger training dataset used to fine-tune the decoder portion of the transformer-based ASR model. This approach enhances the training data by ensuring quality through filtering while expanding coverage through synonymous variations.

One or more embodiments generate code-switched bi-grams using a language model to create ASR training data (Operation 1002). The language model, configured with prompt engineering instructions, generates bi-grams that include one Hindi word in Devanagari script and one English word in Latin script. The model uses example code-switched sentences as few-shot prompts. A filtering process validates the bi-grams by removing duplicates, confirming the presence of both languages, and ensuring words are not direct translations. The validated bi-grams serve as components for generating varied natural sentences with different primary languages.

One or more embodiments employ a filtering component that processes code-switched bi-grams from a language model through multiple steps: removing duplicates, validating the presence of both Hindi and English characters, and confirming words are not direct translations (Operation 1004). In an example implementation, the filtering reduces tens of thousands initial bi-grams to thousands valid bi-grams that accurately represent Hindi-English code-switching patterns. These filtered bi-grams then serve to generate training sentences for fine-tuning an ASR model.

One or more embodiments generate synonymous variations of filtered bi-grams to expand a transformer-based ASR model's training dataset (Operation 1006). After filtering code-switched bi-grams, the embodiments create semantically equivalent versions using different word choices while maintaining code-switching patterns between languages. The synonymous variations provide additional examples of natural language transitions at code-switch points, helping the ASR model recognize different expressions of concepts during language switches. The expanded bi-gram set enriches the training data with more vocabulary combinations and linguistic patterns for real-world usage.

One or more embodiments generate code-switched training sentences through a multi-step process using a language model. The process begins by using the language model to generate code-switched bigrams by providing the language model with example sentences that include mixed language content. For example, when generating Hindi-English bigrams, the language model receives prompts that include sample Hindi-English mixed sentences to guide the generation.

One or more embodiments then apply filtering to the generated bigrams to ensure quality and validity. The filtering removes duplicate bigrams and verifies that each bigram properly includes words from both languages rather than just translations. A script checks that each bigram includes both Hindi and English characters. The language model also helps verify that paired words are not direct translations of each other.

One or more embodiments then create variations of the filtered bigrams by having the language model generate multiple sentences incorporating each valid bigram. For each filtered bigram, the language model generates multiple sentences with different language balances—some with the first language as dominant and others with the second language as dominant. This creates diverse training examples while maintaining natural code-switching patterns based on the original filtered bigrams.

Through this systematic process of generation, filtering, and variation creation, one or more embodiments produce high-quality, code-switched training sentences that incorporate valid language mixing patterns. This helps ensure the training data effectively captures realistic code-switching behavior for improving the ASR system's capabilities.

### 3.4 Code-Switched Training Sentence Generation

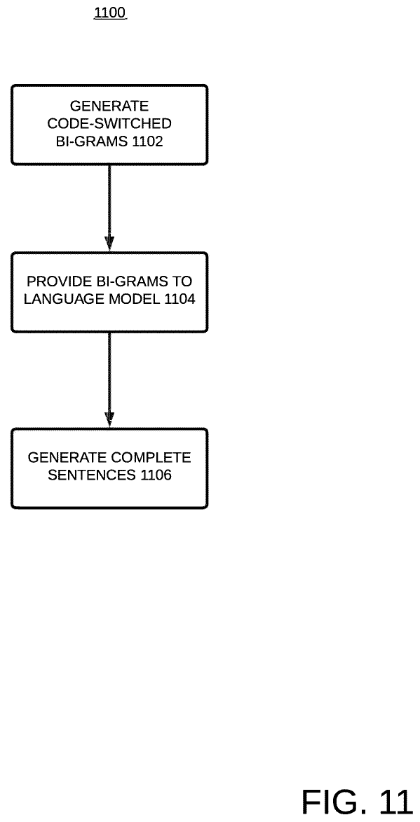

FIG. 11 illustrates a system 1100 for generating code-switched training sentences by creating bi-grams from two languages and using a language model to produce natural flowing sentences according to one or more embodiments.

One or more embodiments generate code-switched training sentences through a multi-step process using a language model. The process begins by creating code-switched bi-grams that include words from both the first and second languages. These bi-grams serve as foundational building blocks for generating more complex code-switched content. The system provides these code-switched bi-grams to a language model as keywords to guide sentence generation. The language model then constructs complete sentences that naturally incorporate the provided bi-grams. When generating these sentences, the language model maintains natural language flow in both languages, paying particular attention to the transition points where the language switches occur. This approach builds upon the earlier steps of obtaining code-switched N-grams from example inputs and ensures the generated training sentences have linguistic coherence while incorporating the desired code-switching patterns. The resulting sentences contribute to a training dataset that helps fine-tune the decoder portion of the transformer-based ASR model to better handle code-switching scenarios.

One or more embodiments generate code-switched bi-grams using a language model acting as a “mix-bigrams generator” that is fluent in both Hindi and English (Operation 1102). The language model creates word pairs combining one Hindi word (in Devanagari script) with one English word (in Latin script) through prompt engineering guided by example code-switching patterns. The generated bi-grams avoid mere translations and serve as building blocks for code-switched training sentences in ASR systems.

One or more embodiments provide bi-grams that include one Hindi word (in Devanagari script) and one English word (in Latin script) to a language model to generate natural, code-switched training sentences (Operation 1104). The language model generates four sentences per bi-gram through a prompt-two with English as the primary language and two with Hindi as the primary language. This preserves natural language flow at code-switch points and creates realistic training data representing natural Hindi-English language mixing in conversation.

One or more embodiments use a language model to generate synthetic training sentences including code-switched bigrams (Operation 1106). The model generates four sentences per bigram-two with the first language as primary and two with the second language as primary. When generating Hindi-English code-switched content, the model receives prompts to naturally incorporate Hindi-English bigrams into sentences. The model maintains natural flow at code-switch points by seamlessly integrating bigrams into both languages' sentence structures. This process creates tens of thousands of unique synthetic sentences that help train ASR systems to better handle language transitions at code-switch points.

One or more embodiments generate natural-sounding, code-switched training sentences using a two-stage process involving a language model. In the first stage, the system generates code-switched bigrams that include one word from each language. The system provides these code-switched bigrams as input keywords to the language model. In the second stage, the language model expands each bigram into complete sentences that incorporate the code-switched bigram pairs while maintaining natural language patterns and flow.

The language model generates multiple sentences for each bigram, producing some sentences that primarily use the first language with the code-switched bigram embedded naturally and other sentences that primarily use the second language with the same bigram. This approach ensures the training data includes diverse examples of how the code-switched bigrams appear in different language contexts. For example, when working with Hindi-English code-switching, the language model generates two sentences with English as the main language and two sentences with Hindi as the main language for each Hindi-English bigram.

The system carefully controls the sentence generation process to maintain natural transitions at the points where the language switches occur. This controlled generation helps create training examples that reflect realistic code-switching patterns rather than awkward or unnatural language transitions. The language model's ability to understand both languages allows the language model to generate sentences that preserve proper grammar and idiomatic expression while incorporating the code-switched elements.

### 3.5 Domain-Specific Code-Switched Content Generation

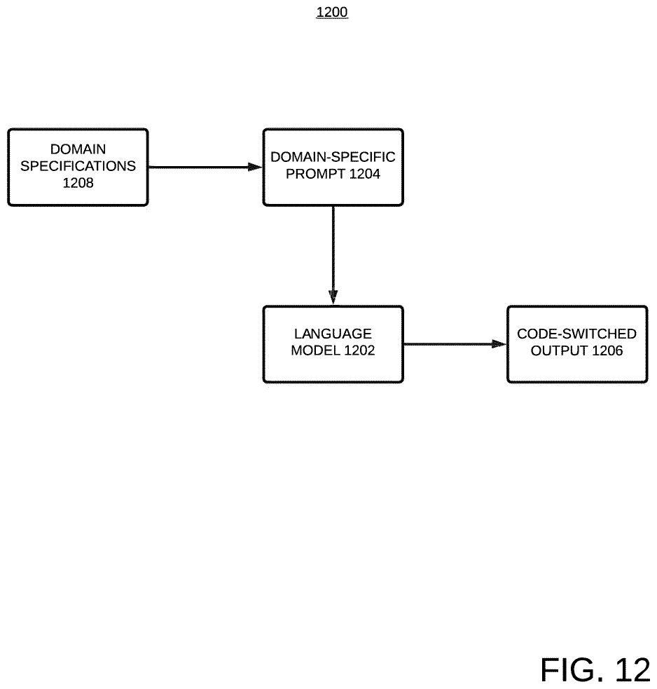

FIG. 12 illustrates a system 1200 for generating domain-specific code-switched training sentences using a language model with specialized prompts for educational, healthcare, and clinical domains according to one or more embodiments.

One or more embodiments generate domain-specific, code-switched training sentences by providing targeted prompts to a language model. The language model receives prompts tailored to specific domains, including educational content, healthcare conversations, or clinical documentation. For example, when generating training sentences for educational content, the prompts may focus on classroom interactions or academic discussions that naturally mix two languages. In healthcare scenarios, the prompts may target patient-provider conversations or medical terminology that commonly involves code-switching. For clinical documentation, the prompts may emphasize medical record entries where healthcare providers alternate between languages. The language model uses these domain-specific prompts along with the previously obtained, code-switched N-grams to generate training sentences that reflect realistic code-switching patterns within these specialized contexts. This domain-focused approach helps create training data that better represents how bilingual speakers switch between languages in specific professional or institutional settings. The domain-specific training sentences are then used to fine-tune the decoder portion of the transformer-based ASR model, enabling the transformer-based ASR model to better recognize code-switching patterns in these targeted scenarios.

One or more embodiments use a language model 1202 to generate domain-specific, code-switched training sentences by providing the language model 1202 with crafted prompts that specify domain context. The model 1202 processes example sentences with natural code-switching patterns, generates code-switched bigrams between two languages, and expands them into full sentences while maintaining domain context. The prompts include system-level instructions defining the model 1202's role as a bilingual generator and user-level instructions specifying output format and domain constraints, enabling creation of synthetic training data that matches target domain code-switching characteristics.

One or more embodiments provide domain-specific prompts 1204 to the language model 1202 to generate code-switched training sentences for specific domains. The prompts include domain examples, such as tutorial content for educational domains, to guide generation of code-switched N-grams and sentences that match natural language patterns in that domain. This creates synthetic training data that matches real-world code-switching in specialized contexts, like education and healthcare, improving ASR model performance for domain-specific code-switching.

One or more embodiments generate code-switched training sentences 1206 by providing domain-specific prompts to the language model 1202. The language model 1202 generates four sentences for each valid code-switched bigram-two with English as the main language and two with Hindi as the main language. When targeting educational content, the language model 1202 receives example sentences from spoken tutorials as few-shot prompts to generate new sentences that maintain appropriate style and vocabulary. This domain-specific approach creates synthetic training data that matches the target use case, enabling fine-tuning of the transformer-based ASR model's decoder for improved code-switching recognition.

One or more embodiments use domain specification options 1208 to customize code-switched training sentences for specific target domains, such as education, healthcare, and clinical documentation. These options 1208 guide the language model 1202 to produce domain-appropriate content through relevant prompts and examples, ensuring the synthetic code-switched sentences reflect realistic language patterns and terminology for each domain's context and requirements.

One or more embodiments generate domain-specific, code-switched training sentences by providing targeted prompts to a language model. The language model uses these prompts to create training sentences that match specific domains, like educational content, healthcare conversations, or clinical documentation. For example, when targeting educational content, one or more embodiments provide the language model with example sentences from technical tutorials that include natural code-switching between languages. The language model then generates new code-switched sentences that maintain the technical vocabulary and speech patterns typical of educational lectures. This domain-specific approach helps ensure the synthetic training data closely matches the real-world scenarios where the ASR system will be deployed. By generating training sentences tailored to specific domains, one or more embodiments create more relevant and effective training data compared to generic, code-switched sentences. The domain-specific prompts guide the language model to incorporate appropriate terminology, context, and language mixing patterns that occur naturally in that domain.

### 3.6 Two-Stage Fine-Tuning Process

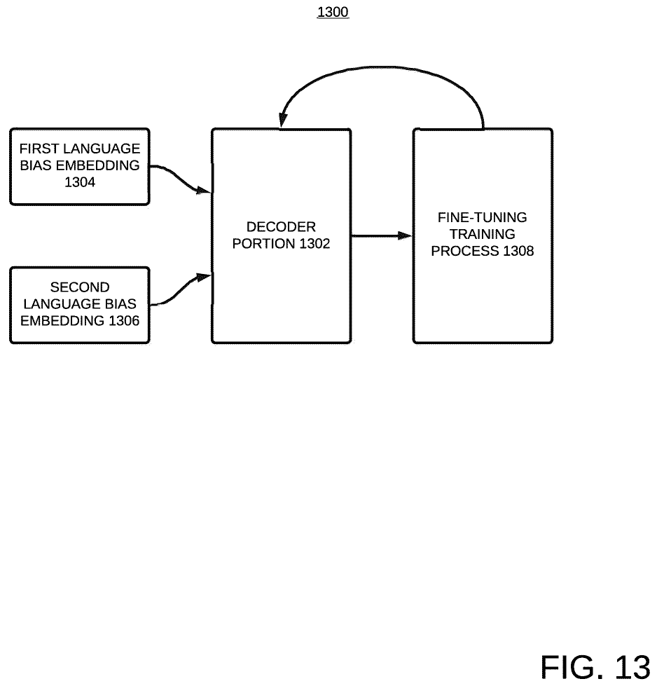

FIG. 13 illustrates a system 1300 for fine-tuning a decoder portion of an ASR model using language-specific bias embeddings for multiple languages during training according to one or more embodiments.

One or more embodiments fine-tune the decoder portion of the transformer-based ASR model by incorporating language-specific bias embeddings during the training process. These bias embeddings are distinct for each language involved in the code-switching specifically one set for the first language and another set for the second language. The language-specific bias embeddings help the decoder learn and maintain the unique characteristics and patterns of each language while processing code-switched speech. During training, the system applies these bias embeddings to guide the decoder's predictions and improve the decoder's ability to accurately handle transitions between the first and second languages. This approach enhances the model's capability to recognize and process code-switched speech by maintaining awareness of language-specific features while working with the training dataset of code-switched sentences that incorporate the generated N-grams.

One or more embodiments fine-tune a decoder portion 1302 of a transformer-based ASR model using language-specific bias embeddings during training. The decoder processes encoder outputs while using distinct bias embeddings for each language in code-switching scenarios. These bias embeddings serve as context signals to guide the decoder in handling transitions between languages. For Hindi-English code-switching, separate bias embeddings for Hindi and English help the decoder accurately transcribe speech, including language switches.

One or more embodiments implement a first language bias embedding 1304 that applies language-specific bias embeddings when processing speech, including a first language, during training. The bias embeddings act as learned weights that help a transformer-based ASR model's decoder recognize language transitions. The embedding works with language-specific prompts (e.g., “<|hi|>” for Hindi) to enhance recognition of the first language while maintaining code-switch awareness. The bias embeddings guide the decoder's attention for mixed-language speech, improving code-switched speech recognition performance at language transition points.

One or more embodiments implement a second language bias embedding 1306 that processes language-specific bias embeddings during decoder fine-tuning of a transformer-based ASR model. The embedding works with code-switched training sentences and helps distinguish between languages by providing dedicated embedding representations for the second language. These bias embeddings serve as additional context for more accurate transcription of code-switched speech including multiple languages.

One or more embodiments incorporate language-specific bias embeddings during ASR training to improve code-switching performance. The training process 1308 applies distinct embeddings for each language to help the transformer-based, ASR model's decoder distinguish between languages and handle language transitions. These embeddings serve as language-aware signals that guide mixed-language speech processing, building on findings that language prompts enhance fine-tuning performance. The language-specific bias embeddings provide context for accurate recognition and transcription of code-switched speech.

One or more embodiments enhance code-switching ASR performance by incorporating language-specific bias embeddings during the fine-tuning process. The decoder portion of the transformer-based ASR model uses distinct embeddings for each language involved in the code-switching task. For example, when training on Hindi-English code-switched speech, the model applies a Hindi-specific embedding when processing Hindi words and an English-specific embedding when processing English words. These language-specific bias embeddings help the model better distinguish between the languages during decoding.

The language-specific embeddings act as additional context signals that guide the decoder's predictions. By maintaining separate bias embeddings for each language, the model can better capture the unique characteristics and patterns of each language. This approach helps prevent confusion between languages at code-switch points where the speech transitions between languages. For instance, when processing a Hindi-English code-switched utterance, the decoder uses English embeddings for English words and switches to Hindi embeddings for Hindi words, enabling more accurate transcription at the language boundary.

The use of language-specific bias embeddings aligns with the experimental results showing improved code-switch bigram accuracy (CBA) when using language-specific prompts during training. Models using this approach demonstrate better ability to handle seamless transitions between languages in code-switched speech.

### 3.7 Language-Specific Bias Embeddings

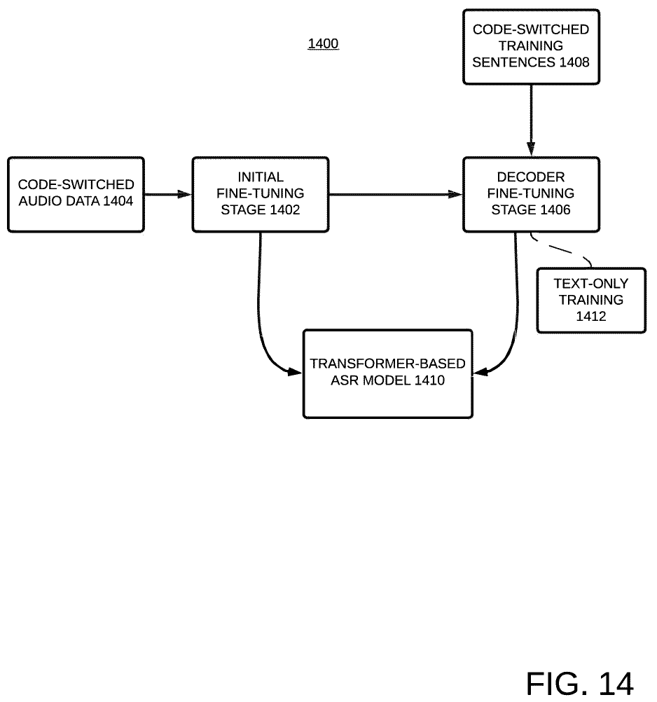

FIG. 14 illustrates a system 1400 for performing two-stage fine-tuning of a transformer-based ASR model using code-switched audio data and code-switched training sentences according to one or more embodiments.

One or more embodiments perform a two-stage, fine-tuning process to enhance the code-switching capabilities of a transformer-based ASR model. In the first stage, the system conducts initial fine-tuning using code-switched audio data. This initial stage enables the ASR model to learn fundamental code-switching patterns and scenarios from actual audio examples. After completing the initial, audio-based fine-tuning, the system performs a second fine-tuning stage that focuses specifically on the decoder portion of the model. This second stage uses the generated, code-switched training sentences for text-only training. The text-only training expands the model's coverage of code-switching patterns while preserving the audio recognition capabilities that were developed during the initial fine-tuning stage. By using this two-stage approach, one or more embodiments leverage both audio and text data to create a more robust code-switching ASR system. The first stage establishes the foundational audio processing capabilities with real code-switched speech, while the second stage broadens the model's understanding of code-switching patterns through text-based learning.

One or more embodiments perform initial fine-tuning 1402 of a transformer-based ASR model using code-switched audio data to establish foundational code-switching capabilities. The fine-tuning uses real code-switched audio samples that include authentic examples of speakers switching between languages within utterances. This stage builds upon the transformer-based ASR model by using either a small subset or complete set of in-domain training data to establish language transition patterns, preparing the model for subsequent text-only training with synthetic code-switched sentences while maintaining audio recognition capabilities.

One or more embodiments perform initial fine-tuning of a transformer-based ASR model using code-switched audio data 1404 that includes speech segments where speakers switch between two languages within the same utterance. The code-switched audio data 804 provides authentic examples of language transitions, pronunciation patterns, and acoustic characteristics of code-switched speech. This initial audio-based training establishes foundational capabilities for recognizing code-switching before proceeding with text-based training stages, helping preserve audio recognition capabilities while expanding code-switching pattern coverage.

One or more embodiments perform decoder fine-tuning 1406 as a training phase after initial fine-tuning with code-switched audio data. The decoder fine-tuning uses text-only training with code-switched sentences generated by a language model. This approach preserves the transformer-based ASR model's audio recognition capabilities while expanding the transformer-based ASR model's ability to handle diverse code-switching patterns. The fine-tuning uses a training dataset of code-switched sentences that incorporate N-grams produced by the language model. By separating audio-based, initial fine-tuning from text-focused, decoder fine-tuning, the model maintains speech recognition abilities while learning additional code-switching patterns.

One or more embodiments use code-switched training sentences 1408 in a two-stage fine-tuning process for ASR models. The first stage uses these sentences with audio to teach basic code-switching patterns, while the second stage uses text-only training to expand code-switching capabilities while preserving audio recognition. The training sentences incorporate code-switched N-grams to represent natural language transitions between first and second languages.

One or more embodiments implement a two-stage, fine-tuning process for a transformer-based ASR model 1410 that includes one billion parameters or more and processes log-Mel spectrograms of audio up to 30 seconds long. The first stage fine-tunes the entire model using code-switched audio data to learn basic code-switching patterns. The second stage fine-tunes the decoder portion using generated, code-switched text sentences to expand pattern coverage while maintaining audio recognition capabilities. The model uses an encoder-decoder architecture optimized with mixed-precision training and AdamW optimizer to effectively handle code-switching between languages, like Hindi and English.

One or more embodiments use text-only training 1412 as part of a two-stage, fine-tuning process for ASR systems. After initial fine-tuning with code-switched audio data, the system uses generated, code-switched training sentences to expand code-switching pattern recognition. The text-only training targets the decoder portion of the transformer-based ASR model while preserving audio recognition capabilities. This approach leverages code-switched N-grams and sentences to expose the ASR system to more code-switching patterns than audio training data alone could provide, enhancing coverage without requiring additional audio data.

One or more embodiments enhance the code-switching capabilities of a transformer-based ASR model through a two-stage, fine-tuning process. The first stage uses code-switched audio data to establish foundational code-switching recognition patterns. This initial training helps the model learn basic scenarios where speakers switch between languages within their speech.

The second stage builds upon this foundation by performing text-only training using synthetically generated, code-switched sentences. These sentences incorporate N-grams, including words from both languages, that were generated by a language model. The text-only training expands the model's ability to handle diverse code-switching patterns while preserving the audio recognition capabilities developed in the first stage.

One or more embodiments leverage this two-stage approach to address the challenge of limited, code-switched training data. The initial, audio-based fine-tuning provides the model with real-world examples of code-switching pronunciation and acoustic patterns. The subsequent, text-based training then augments this knowledge by exposing the model to a broader range of language switching scenarios without requiring additional audio recordings. This approach effectively combines the benefits of acoustic pattern learning from real speech with expanded coverage of code-switching patterns from synthetic text data.

The decoder portion of the transformer-based ASR model receives focused training during the text-only stage. This targeted training helps the model better predict transcriptions that include code-switching while maintaining the model's ability to process the acoustic features learned during initial fine-tuning. The combination of audio-based and text-only training creates a more robust model capable of handling diverse code-switching scenarios in real-world applications.

### 3.8 Language Model Configuration For Code-Switched ASR

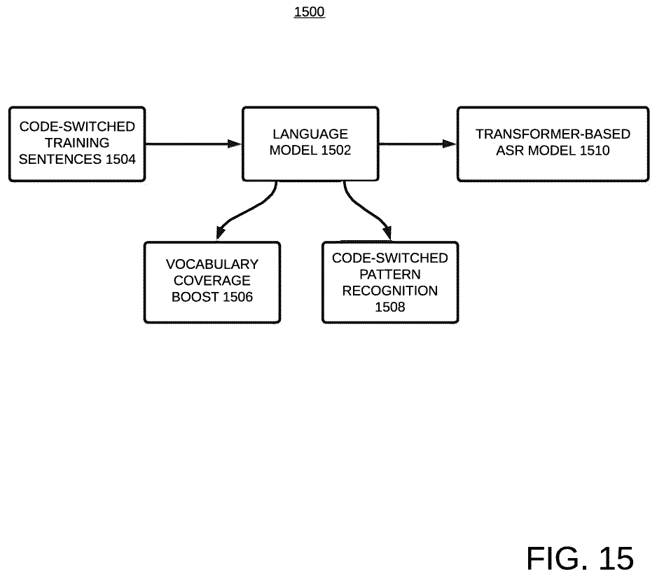

FIG. 15 illustrates a system 1500 for training a language model using code-switched sentences to boost vocabulary coverage and complement transformer-based ASR recognition of code-switched patterns according to one or more embodiments.

One or more embodiments train a language model using code-switched training sentences generated from the transformer-based ASR model's training dataset. The language model boosts vocabulary coverage for utterances that mix words from different languages. This expanded vocabulary coverage helps handle real-world scenarios where speakers naturally switch between languages within conversations. The language model works in conjunction with the transformer-based ASR model to provide improved recognition capabilities for speech patterns that include code-switching. The complementary nature of the two models-the transformer-based ASR model and the language model-creates a more robust system for handling code-switched speech. The language model specifically focuses on enhancing the system's ability to recognize and process utterances that combine vocabulary from multiple languages, building upon the code-switched N-grams and training sentences used to fine-tune the transformer-based ASR model's decoder portion.

One or more embodiments include a language model 1502 that trains on code-switched sentences to improve code-switched speech recognition. The language model 1502 component expands vocabulary coverage for mixed-language utterances and enhances recognition accuracy alongside a transformer-based ASR model. The language model 1502 trains on code-switched N-grams generated by prompting a language model, learning to model language transitions at code-switching points. This approach addresses limited training data availability by using synthetic examples with natural code-switching patterns.

One or more embodiments include an input connection that feeds code-switched training sentences 1504 into the language model 1502. The input connection delivers training data generated from code-switched N-grams, that include words from two languages. This enables the language model 1502 to process code-switched sentences, expand the language model 1502's vocabulary for code-switched utterances, and improve recognition accuracy for speech patterns where speakers switch between languages. The input connection enhances the transformer-based ASR model's capabilities by facilitating training data flow that improves performance on code-switching tasks, particularly with limited data.

One or more embodiments include a vocabulary coverage boost module 1506 that processes code-switched training sentences from N-grams to expand vocabulary coverage for multi-language utterances. The module trains a language model on these sentences to improve prediction of word sequences, including language transitions. This enhances recognition accuracy at language switch points and addresses limited training data by ensuring broad coverage of common code-switching patterns in spontaneous speech.

One or more embodiments include a code-switched pattern recognition module 1508 that trains a language model using code-switched training sentences that include words from multiple languages. The language model 1508 processes training sentences generated from N-grams that include words from a first and second language, where the N-grams are produced by a language model based on code-switching examples. This training complements a transformer-based ASR model and improves recognition of mixed-language speech patterns where speakers switch between languages within utterances. The code-switched pattern recognition module 1508 addresses limited training data availability by using generated sentences to expand code-switching recognition capabilities.

One or more embodiments connect a language model trained on code-switched sentences to a transformer-based ASR model. The language model enhances ASR performance by expanding vocabulary coverage for multi-language utterances and improving recognition of language-switching patterns. The language model learns from training sentences that include N-grams with words from two languages, enabling the language model to understand common code-switching patterns and build multi-language vocabulary.

One or more embodiments employ a transformer-based ASR model 1510 working with a language model trained on code-switched sentences to process speech input. The ASR model converts log-Mel spectrograms using a sequence-to-sequence approach and handles 30-second audio segments, using chunking for longer inputs. The language model enhances vocabulary coverage for code-switched speech, improving recognition when speakers switch between languages by leveraging patterns learned from code-switched training data.

One or more embodiments improve code-switching ASR performance by incorporating additional language model training using the generated code-switched training sentences. The language model works in conjunction with the transformer-based ASR model to enhance recognition of mixed-language speech patterns.

Specifically, after generating the code-switched training sentences using the language model, one or more embodiments train a dedicated language model on this synthetic dataset. The language model serves two key purposes. First, the language model expands the vocabulary coverage for utterances that mix multiple languages together. Second, the language model acts as a complementary component to the transformer-based ASR model to better handle code-switching patterns.

The trained language model helps address challenges faced by the ASR system when processing speech that seamlessly switches between languages. By learning from the synthetic code-switched training data, the language model develops a better understanding of common patterns and transitions between the languages. The language model allows the language model to work alongside the fine-tuned ASR model to improve overall recognition accuracy for code-switched speech.

This complementary language modeling approach provides additional linguistic context that helps the ASR system more accurately transcribe speech encompassing frequent language switches. The expanded vocabulary coverage and learned code-switching patterns enable more robust handling of mixed-language utterances compared to using the ASR model alone.

### 4. Example Embodiments

Detailed examples are described below for purposes of clarity. Components and/or operations described below should be understood as one specific example that may not be applicable to certain embodiments. Accordingly, components and/or operations described below should not be construed as limiting the scope of any of the claims.

One or more embodiments may be used to train a speech recognition model to handle English-Spanish code-switched speech. In these embodiments, a collection of English audio recordings from native English speakers and a separate collection of Spanish audio recordings from native Spanish speakers are received as input. During training, the system selects specific segments from both collections—for example, a 3-second clip of an English speaker saying “I need to buy” and a 2-second clip of a Spanish speaker saying “una camisa nueva.” These segments are then combined to create a synthetic code-switched audio sample that sounds like “I need to buy una camisa nueva.” Multiple such combinations are generated to create a set of synthetic code-switched samples. Each synthetic sample is then evaluated against training constraints, such as if the total duration is under 30 seconds and if the audio transition between languages sounds natural. Samples that satisfy these constraints, like the “I need to buy una camisa nueva” example, are used to train the speech recognition model, while samples that don't meet the constraints, such as those with unnatural breaks or poor audio quality at the transition point, are filtered out. Through this process, one or more embodiments enable the speech recognition model to learn how to handle natural language switching between English and Spanish even without access to large amounts of real code-switched speech data.

One or more embodiments improve Hindi-English code-switching ASR by first providing a language model with example code-switched sentences. Using these examples as few-shot prompts, the language model generates code-switched bigrams (N=2). The language model then uses these generated bigrams to create complete training sentences that naturally incorporate the code-switching patterns. These generated sentences form a synthetic training dataset that captures diverse code-switching scenarios. Finally, one or more embodiments use this synthetic dataset to fine-tune the decoder portion of a transformer-based ASR model like Whisper, enhancing its ability to accurately transcribe Hindi-English code-switched speech. This targeted fine-tuning helps the ASR model better handle the transitions between Hindi and English words that occur naturally in bilingual conversations.

### 5. Practical Applications, Advantages, and Improvements

One or more embodiments are particularly valuable in settings where code-switching is common but collecting large amounts of real code-switched speech data is challenging and expensive. For example, these embodiments can be deployed to improve ASR systems used in customer service centers, educational settings, or voice assistants in multilingual settings where speakers frequently switch between languages.

One or more embodiments provide cost and time savings by eliminating the need to collect, transcribe, and annotate large amounts of real code-switched speech data. Instead, they leverage readily available monolingual speech data to create synthetic training examples. This approach is especially advantageous because monolingual speech data is typically abundant and easier to obtain than code-switched data.

Furthermore, one or more embodiments improve the robustness and accuracy of speech recognition systems by exposing them to a diverse range of synthetic code-switch points during training. The ability to filter synthetic samples based on training constraints ensures that high-quality examples are used for training, leading to better model performance.

Additionally, one or more embodiments are language-agnostic and can be adapted to work with any pair of languages, making them particularly valuable for developing ASR systems for previously underserved language combinations where code-switched training data is scarce or non-existent. By enabling the development of more accurate multilingual ASR systems, one or more embodiments help bridge communication gaps and improve accessibility of speech technology in multilingual communities.

One or more embodiments have practical applications in multilingual and professional settings where code-switching is common, such as international business meetings, technical education, customer service centers, and social media content. For example, in Indian technical education, where instructors frequently switch between Hindi and English while teaching, these embodiments can improve the accuracy of automated lecture transcription. In customer service scenarios, these embodiments can enhance the quality of call transcriptions where both agents and customers naturally mix languages during conversations.

The advantages of one or more embodiments are particularly notable in addressing the persistent challenge of limited code-switched training data. By using a language model to generate synthetic training data, these embodiments eliminate the need for expensive and time-consuming collection of real code-switched speech data. Furthermore, these embodiments can be quickly adapted to new domains or language pairs by simply providing relevant example sentences to the language model, making them highly flexible and cost-effective.

One or more embodiments provide several key improvements over existing approaches. First, they offer a more systematic and controlled way to generate code-switched training data by first creating N-grams and then expanding them into full sentences, ensuring natural and domain-appropriate language mixing patterns. Second, by specifically fine-tuning the decoder portion of the transformer-based ASR model, these embodiments focus on improving the part of the model focused on handling language transitions, leading to more efficient training. Third, these embodiments create a scalable pipeline for improving code-switching ASR capabilities across different language pairs and domains, addressing a significant gap in current ASR technology. These improvements are useful as they enable ASR systems to better serve multilingual settings where code-switching is a natural part of daily communication.

### 6. Example Language Model Architecture

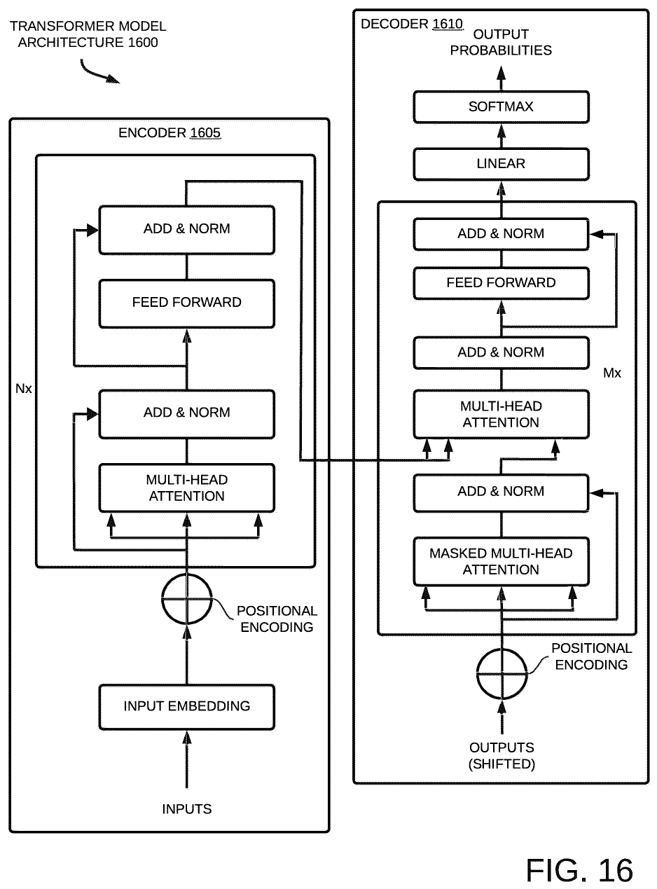

FIG. 16 illustrates an example transformer model architecture 1600 that is used in the implementation of a language model according to one or embodiments of the present disclosure. As a non-limiting example, architecture 1600 may be used in the implementation of a large language model or other type of language model.

A large language model is a type of artificial neural network designed to understand, generate, and manipulate natural language based on extensive training on vast text datasets. These models, built on transformer architectures like the one illustrated in FIG. 16, use self-attention mechanisms to process sequential data and capture complex language patterns. Large language models can have billions or even trillions of parameters, enabling them to perform a wide range of language tasks such as text generation, translation, summarization, and question answering with remarkable fluency and contextual understanding.

Architecture 1600 may be used in implementing various other types of language models beyond large language models. These include medium-sized language models, which maintain robust capabilities while requiring fewer computational resources; specialized domain-specific models trained on targeted datasets for fields like medicine, law, or finance; multilingual models designed to process and generate text across multiple languages simultaneously; multimodal models that integrate language understanding with other data types such as images or audio; and smaller, distilled models that compress the knowledge of larger models into more efficient frameworks. Each of these model types leverages the transformer architecture's attention mechanisms and parallel processing capabilities, but with different parameter counts, training objectives, or architectural modifications tailored to their specific use cases and deployment constraints.

The transformer model architecture 1600 is a neural network design for natural language processing. The architecture 1600 encompasses an encoder 1605 and a decoder 1610, both leveraging self-attention mechanisms. The architecture 1600 begins with an input embedding layer that converts tokens into high-dimensional vector representations that range, for example, from 128 to 1024 dimensions. These embeddings are augmented with positional encodings to retain sequence order information.

The transformer model architecture 1600's input embedding layer serves as the initial processing stage for converting discrete tokens into continuous vector representations. These dense embeddings occupy a high-dimensional space, with dimensionality configurations ranging from 128 to 1024, allowing for rich semantic representation of input tokens. The embedding process maps a token to a unique vector that captures the token's semantic properties in the continuous space. Positional encodings are subsequently added to these token embeddings through element-wise addition, introducing position-dependent signals that encode sequential information. These positional encodings are implemented using sinusoidal functions or learned parameters, enabling the model to differentiate between tokens based on their positions in the sequence. The combined embeddings preserve both semantic content and sequential order, forming a foundation for the subsequent self-attention mechanisms. This embedding strategy addresses the inherent limitation of transformer architectures in processing sequential data, as the self-attention mechanism alone is position-agnostic.

The architecture 1600 includes a multi-head, self-attention mechanism. This allows the architecture 1600 to simultaneously attend to different parts of the input sequence, capturing various types of relationships and dependencies. An attention head computes query, key, and value vectors, enabling the model to focus on relevant parts of the input when processing a token. Following the attention layers, the architecture 1600 incorporates feed-forward neural networks with multiple layers and non-linear activation functions.

The multi-head self-attention mechanism forms a component of the transformer architecture 1600, enabling parallel processing of input sequence elements. An attention head operates as an independent attention mechanism, computing three distinct matrices: queries (Q), keys (K), and values (V) through learned linear transformations of the input embeddings. The parallel nature of multiple attention heads allows the model to capture diverse relationship patterns within the same input sequence simultaneously, such as syntactic dependencies, semantic relationships, and long-range contextual connections. The attention computation follows the scaled dot-product attention formula, where the dot product between queries and keys determines alignment scores, followed by scaling and softmax normalization to produce attention weights. These weights are then applied to the value vectors, creating context-aware representations. The feed-forward neural networks following the attention layers include two linear transformations with a non-linear activation function (e.g., ReLU or GELU) between them, processing a position's output independently. This combination of self-attention and position-wise feed-forward networks enables the model to alternate between gathering contextual information across the sequence and applying complex transformations to individual positions, creating a powerful mechanism for sequence processing.

A masked multi-head attention mechanism in the decoder 1610 of a transformer architecture 1600 is designed to prevent the model from attending to future tokens during sequence generation. In this mechanism, multiple attention heads operate in parallel, a computing query (Q), key (K), and value (V) matrices from the input embeddings. The attention scores are calculated as the dot product of Q and K, scaled by the inverse square root of the dimension of the keys. A lower triangular mask is applied to these attention scores before softmax normalization, effectively setting the upper triangular elements to negative infinity. This masking ensures that a position can attend to previous positions in the sequence, maintaining the autoregressive property of the decoder. The masked attention scores are then used to compute a weighted sum of the value vectors. The outputs from the heads are concatenated and linearly transformed to produce the attention output. This process allows the decoder to generate tokens sequentially while considering the previously generated tokens, thus preserving the causal nature of language modeling.

The masked multi-head attention mechanism in the transformer's decoder 1610 implements causal masking to enforce autoregressive generation during sequence processing. An attention head performs linear projections to create query (Q), key (K), and value (V) matrices from input embeddings through learned weight matrices WQ, WK, and WV respectively. The attention computation follows the formula Attention (Q, K, V)=softmax(QK^{T}/√dk)V, where dk represents the dimensionality of the key vectors. A lower triangular mask matrix gets added to the attention scores before softmax normalization. This mask sets all upper triangular elements to negative infinity (−∞), effectively zeroing out these positions after the softmax operation. The masking operation ensures strict causality by preventing any position from attending to future positions in the sequence during both training and inference. Following the masked attention computation, the outputs from multiple attention heads are concatenated along the feature dimension and projected through a final linear transformation WO to produce the layer's output. This output maintains the temporal causality required for autoregressive generation while still allowing a position to attend to all previous positions in the sequence. The parallelized implementation of multiple attention heads enables the model to capture various aspects of the sequence history simultaneously, while the masking mechanism maintains the sequential nature of language generation.

To maintain stable training and mitigate vanishing gradients, the architecture 1600 employs layer normalization after a sub-layer (self-attention and feed-forward networks) and introduces residual connections. These residual connections allow unimpeded information flow through the network. The model includes multiple (Nx) encoder and decoder (Mx) layers stacked on top of each other, increasing its capacity to learn complex language patterns.

The transformer architecture incorporates stabilization techniques through layer normalization and residual connections. Layer normalization is applied after both the self-attention and feed-forward network sub-layers, normalizing the activations across the feature dimension for a token position. The normalization process computes the mean and variance of the features, then scales and shifts the normalized values using learned parameters gamma and beta, effectively standardizing the feature distributions throughout the network. Residual connections, implemented as skip connections, add the input of a sub-layer to the transformed output, creating direct paths for gradient flow during backpropagation. The combination of these components follows the formula LayerNorm(x+Sublayer(x)), where x represents the input and Sublayer represents either the self-attention or feed-forward network.

The stacking of multiple encoder and decoder layers increases the model's capacity logarithmically with respect to sequence length, enabling the capture of hierarchical patterns in language. An additional layer in the stack provides an opportunity for more abstract feature representation, with lower layers capturing local patterns and higher layers learning more complex, global dependencies. The interaction between layer normalization and residual connections creates a well-conditioned optimization landscape, facilitating stable training of deep transformer networks while mitigating the vanishing gradient problem that commonly affects deep neural architectures.

The output layer involves a linear transformation followed by a softmax function, producing probability distributions over the vocabulary for text generation tasks. This architecture 1600's design allows for efficient parallel processing of input sequences, making it particularly suitable for handling the extensive datasets used in training language models.

The output layer of the transformer architecture implements a vocabulary-sized classification mechanism through a linear transformation followed by softmax activation. The linear transformation projects the decoder's hidden states onto a vocabulary-sized space using a weight matrix W∈ [symbol] \hat{ }(d_model×|V|), where d_model represents the model's hidden dimension and |V| represents the vocabulary size. The subsequent softmax function normalizes these logits into a proper probability distribution across the entire vocabulary, computing P(token_i)=exp(z_i)/Σ_j exp(z_j), where z_i represents the logit for the i-th vocabulary token. This architectural design enables efficient batch processing of input sequences through matrix multiplications, leveraging modern hardware accelerators like GPUs and TPUs. The parallel computation capability stems from the self-attention mechanism's ability to process all sequence positions simultaneously during the forward pass, requiring O(1) sequential operations compared to the O(n) operations needed in recurrent architectures. The model's parallelization efficiency scales particularly well with increasing sequence lengths, making the architecture advantageous for processing the extensive datasets used in language model training, that often include billions of tokens across diverse domains and languages.

In one or more embodiments, architectural variations enhance or modify the standard transformer design for language model implementations. The sparse transformer introduces structured sparsity patterns in the attention mechanism, reducing the quadratic memory complexity to linear complexity through fixed attention patterns. This modification enables processing of much longer sequences while maintaining model quality. Reformer architectures employ locality-sensitive hashing for attention computation, approximating full attention while significantly reducing memory requirements. The performer architecture replaces the attention mechanism with kernel-based formulations using random feature decomposition, achieving linear complexity in both compute and memory.

Alternate positional encoding schemes offer various trade-offs. Rotary Positional Embeddings (RoPE) inject positional information through rotation matrices applied to token embeddings, providing better relative position modeling. ALiBi (Attention with Linear Biases) position embeddings add learned bias terms to attention scores, enabling better extrapolation to sequences longer than those seen during training. Some architectures eliminate explicit positional encodings entirely, instead relying on position-aware linear attention mechanisms.

Architecture modifications also target specific computational bottlenecks. Flash attention optimizes attention computation through careful management of GPU memory access patterns. Mixture of Experts (MoE) architectures incorporate sub-networks activated based on input patterns, increasing model capacity without proportional computation increases. The GLU (Gated Linear Unit) variants replace standard feed-forward networks with gated mechanisms, providing more flexible function approximation. Multi-query attention reduces memory bandwidth requirements by sharing key and value projections across attention heads while maintaining separate query projections.

Some architectures focus on improved training dynamics. The “DeepNorm” normalization strategy modifies the layer normalization scheme to enable stable training of deeper networks. Gradient checkpointing strategies reduce memory requirements during training by recomputing certain activations during backpropagation. State space models offer an alternative to attention mechanisms entirely, using linear state space equations to model sequence relationships with improved computational efficiency.

Alternative architectures for language model implementation encompass distinct paradigms beyond transformers. Recurrent Neural Networks (RNNs), particularly variants like Long Short-Term Memory (LSTM) networks and Gated Recurrent Units (GRUs), process sequences sequentially through hidden state updates. These architectures maintain explicit temporal dependencies through gating mechanisms, controlling information flow between timesteps. LSTM networks employ three gates—input, forget, and output—along with a memory cell to regulate information persistence. GRUs simplify this structure with reset and update gates while maintaining comparable performance.

Convolutional Neural Networks (CNNs) offer another approach through hierarchical feature extraction. Temporal Convolutional Networks (TCNs) apply dilated convolutions to capture long-range dependencies while maintaining autoregressive properties. The hierarchical structure of TCNs enables parallel processing within a layer while preserving causal relationships. Quasi-Recurrent Neural Networks (QRNNs) combine convolutional and recurrent approaches, using convolution for parallel feature extraction followed by a lightweight recurrent pooling mechanism.

Memory-augmented architectures present another paradigm. Neural Turing Machines (NTMs) and Differentiable Neural Computers (DNCs) supplement neural processing with external memory arrays, accessed through attention-like mechanisms. These architectures separate computation from memory storage, enabling more explicit modeling of long-term dependencies. Memory networks similarly incorporate dedicated memory components but with more structured addressing mechanisms.

Continuous-time models offer an alternative perspective on sequence processing. Neural Ordinary Differential Equations (Neural ODEs) model sequence evolution as a continuous-time dynamical system, solving differential equations to process inputs. This approach enables variable timestep processing and potentially more natural handling of temporal relationships. Similarly, Neural Controlled Differential Equations (Neural CDEs) extend this framework to handle irregular time series data while maintaining end-to-end differentiability.

Graph Neural Networks (GNNs) provide yet another alternative by modeling sequences as structured graphs. This approach enables explicit modeling of hierarchical relationships and long-range dependencies through message passing between nodes. Graph-based architectures capture complex dependencies that are difficult to model with purely sequential approaches, though these architectures require careful design of graph structure and update rules.

In one or more embodiments, the transformer-based language model architecture 1600 is not deployed in isolation but rather serves as a module within an overall reasoning framework. In these systems, the language model is integrated into a multi-stage reasoning pipeline that combines the raw generative capabilities of the transformer with additional processes aimed at structured, step-by-step reasoning.

In such a reasoning framework, the language model may be tasked with generating intermediate representations or “chain-of-thought” outputs. These outputs detail intermediate reasoning steps that help decompose complex queries into manageable sub-tasks. For example, the language model may generate an initial hypothesis or a series of candidate reasoning steps, which are then validated by auxiliary modules responsible for consistency checks, fact verification, or domain-specific reasoning rules. This design enables the system to not only generate fluent natural language responses but also to provide transparency into the reasoning process underlying each response.

Moreover, reasoning architectures may incorporate a controller or supervisory module that orchestrates interactions between the language model and other specialized reasoning components. This controller can guide the selection of reasoning paths, manage iterative refinement (e.g., revising or expanding upon earlier generated steps), and leverage external knowledge bases or memory stores to enhance the overall reasoning performance. In one or more embodiments, additional layers of analysis—such as external search mechanisms or multi-hop reasoning strategies—further empower the system to tackle more complex, context-dependent tasks while ensuring that the output remains coherent and logically sound.

By embedding the language model within a larger reasoning ecosystem, one or more embodiments overcome some of the limitations inherent in standalone transformer architectures, such as the lack of explicit intermediate reasoning steps. The integration fosters a symbiotic relationship where the language model's strength in pattern recognition and language generation complements dedicated reasoning and verification processes. As a result, the overall system is capable of improved decision-making, enhanced problem solving, and more robust handling of tasks that require deep and structured reasoning.

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In one or more embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In one or more embodiments, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to a request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In one or more embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, that are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In one or more embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In one or more embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In one or more embodiments, a tenant is associated with a tenant ID. An network resource of the multi-tenant computer network is tagged with a tenant ID. A tenant is permitted access to a particular network resource if the tenant and the particular network resources are associated with a same tenant ID.

In one or more embodiments, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset if the tenant and the particular application, data structure, and/or dataset are associated with a same tenant ID.

As an example, a database implemented by a multi-tenant computer network may be tagged with a tenant ID. Only a tenant associated with the corresponding tenant ID may access data of a particular database. As another example, a entry in a database implemented by a multi-tenant computer network may be tagged with a tenant ID. Only a tenant associated with the corresponding tenant ID may access data of a particular entry. However, the database may be shared by multiple tenants.

In one or more embodiments, a subscription list indicates that tenants have authorization to access that applications. For an application, a list of tenant IDs of tenants authorized to access the application is stored. A tenant is permitted access to a particular application if the tenant ID of the tenant is included in the subscription list corresponding to the particular application.

In one or more embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

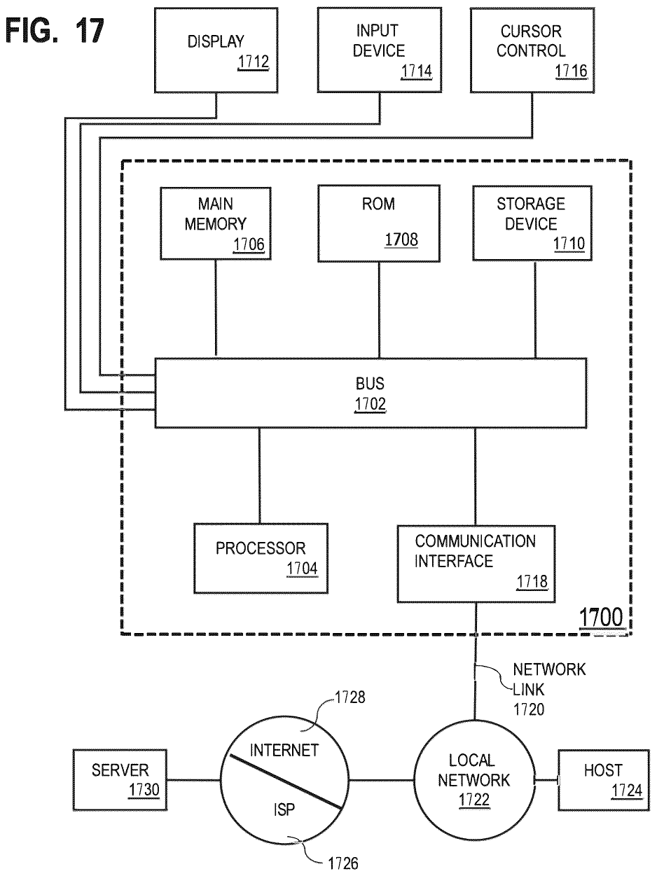

FIG. 17 is a block diagram that illustrates an example computer system 1700 upon which one or more embodiments are implemented. Computer system 1700 includes a bus 1702 or other communication mechanism for communicating information, and a hardware processor 1704 coupled with bus 1702 for processing information. Hardware processor 1704 may be, for example, a general-purpose microprocessor.

Computer system 1700 also includes a main memory 1706, such as a random-access memory (RAM) or other dynamic storage device, coupled to bus 1702 for storing information and instructions to be executed by processor 1704. Main memory 1706 also may be used for storing temporary variables or other intermediate information during execution of instructions to be executed by processor 1704. Such instructions, when stored in non-transitory storage media accessible to processor 1704, render computer system 1700 into a special-purpose machine that is customized to perform the operations specified in the instructions.

Computer system 1700 further includes a read only memory (ROM) 1708 or other static storage device coupled to bus 1702 for storing static information and instructions for processor 1704. A storage device 1710, such as a magnetic disk, optical disk, or a Solid-State Drive (SSD) is provided and coupled to bus 1702 for storing information and instructions.

Computer system 1700 may be coupled via bus 1702 to a display 1712, such as a cathode ray tube (CRT), for displaying information to a computer user. An input device 1714, including alphanumeric and other keys, is coupled to bus 1702 for communicating information and command selections to processor 1704. Another type of user input device is cursor control 1716, such as a mouse, a trackball, or cursor direction keys for communicating direction information and command selections to processor 1704 and for controlling cursor movement on display 1712. This input device typically has two degrees of freedom in two axes, a first axis (e.g., x) and a second axis (e.g., y), that allows the device to specify positions in a plane.

Computer system 1700 may implement the techniques described herein using customized hard-wired logic, one or more ASICs or FPGAs, firmware and/or program logic that in combination with the computer system causes or programs computer system 1700 to be a special-purpose machine. According to one embodiment, the techniques herein are performed by computer system 1700 based on processor 1704 executing one or more sequences of one or more instructions contained in main memory 1706. Such instructions may be read into main memory 1706 from another storage medium, such as storage device 1710. Execution of the sequences of instructions contained in main memory 1706 causes processor 1704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1710. Volatile media includes dynamic memory, such as main memory 1706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1702. Transmission media can also take the form of acoustic or light waves, such as those generated during radio-wave and infra-red data communications.

Various forms of media may be involved in carrying one or more sequences of one or more instructions to processor 1704 for execution. For example, the instructions may initially be carried on a magnetic disk or solid-state drive of a remote computer. The remote computer can load the instructions into its dynamic memory and send the instructions over a telephone line using a modem. A modem local to computer system 1700 can receive the data on the telephone line and use an infra-red transmitter to convert the data to an infra-red signal. An infra-red detector can receive the data carried in the infra-red signal and appropriate circuitry can place the data on bus 1702. Bus 1702 carries the data to main memory 1706, from that processor 1704 retrieves and executes the instructions. The instructions received by main memory 1706 may optionally be stored on storage device 1710 either before or after execution by processor 1704.

Computer system 1700 also includes a communication interface 1718 coupled to bus 1702. Communication interface 1718 provides a two-way data communication coupling to a network link 1720 that is connected to a local network 1722. For example, communication interface 1718 may be an integrated services digital network (ISDN) card, cable modem, satellite modem, or a modem to provide a data communication connection to a corresponding type of telephone line. As another example, communication interface 1718 may be a local area network (LAN) card to provide a data communication connection to a compatible LAN. Wireless links may also be implemented. In any such implementation, communication interface 1718 sends and receives electrical, electromagnetic or optical signals that carry digital data streams representing various types of information.

Network link 1720 typically provides data communication through one or more networks to other data devices. For example, network link 1720 may provide a connection through local network 1722 to a host computer 1724 or to data equipment operated by an Internet Service Provider (ISP) 1726. ISP 1726 in turn provides data communication services through the worldwide packet data communication network now commonly referred to as the “Internet” 1728. Local network 1722 and Internet 1728 both use electrical, electromagnetic or optical signals that carry digital data streams. The signals through the various networks and the signals on network link 1720 and through communication interface 1718, that carry the digital data to and from computer system 1700, are example forms of transmission media.

Computer system 1700 can send messages and receive data, including program code, through the network(s), network link 1720 and communication interface 1718. In the Internet example, a server 1730 might transmit a requested code for an application program through Internet 1728, ISP 1726, local network 1722 and communication interface 1718.

The received code may be executed by processor 1704 as it is received, and/or stored in storage device 1710, or other non-volatile storage for later execution.

### 9. Miscellaneous; Extensions

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner that might adversely affect their validity as trademarks.

Embodiments are directed to a system with one or more devices that include a hardware processor and that are configured to perform any of the operations described herein and/or recited in any of the claims below.

In one or more embodiments, one or more non-transitory computer readable storage media comprises instructions that, when executed by one or more hardware processors, cause performance of any of the operations described herein and/or recited in any of the claims.

In one or more embodiments, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in that such claims issue, including any subsequent correction.

1. A method comprising:
receiving a first plurality of audio samples in a first language and a second plurality of audio samples in a second language;
executing a training process for a speech recognition model, the training process comprising:
selecting a first subset, of the first plurality of audio samples in the first language, and a second subset, of the second plurality of audio samples in the second language, for generating a plurality of synthetic code-switched audio samples;
generating the plurality of synthetic code-switched audio samples based at least on combining the first subset and the second subset, wherein each synthetic code-switched audio sample, of the plurality of synthetic code-switched audio samples, includes audio content in both the first language and the second language;
determining that a first subset of the plurality of synthetic code-switched audio samples satisfies one or more training constraints;
determining that a second subset of the plurality of synthetic code-switched audio samples does not satisfy one or more training constraints; and
training the speech recognition model based at least on the first subset of the plurality of synthetic code-switched audio samples.

2. The method of claim 1, further comprising:
determining that a synthetic code-switched audio sample in the first subset does not exceed a maximum duration threshold.

3. The method of claim 1, further comprising:
selecting a first audio sample, of the first plurality of audio samples in the first language, and selecting a second audio sample, of the second plurality of audio samples in the second language, based at least on determining that a speaker associated with the first audio sample is a same speaker as a speaker associated with the second audio sample; and
generating a synthetic code-switched audio sample, of the plurality of synthetic code-switched audio samples, based at least on the first audio sample and the second audio sample.

4. The method of claim 1, further comprising:
selecting a first audio sample, of the first plurality of audio samples in the first language, and selecting a second audio sample, of the second plurality of audio samples in the second language, based at least on determining that a word in the first language spoken in the first audio sample is code-switch compatible with a word in the second language spoken in the second audio sample; and
generating a synthetic code-switched audio sample, of the plurality of synthetic code-switched audio samples, based at least on the first audio sample and the second audio sample.

5. The method of claim 1, further comprising:
identifying a first document corpus primarily comprising words in in the first language;
detecting one or more occurrences of a word in the second language in the first document corpus;
determining that the one or more occurrences of the word in the second language meet a selection criteria; and
based at least on determining that the one or more occurrences of the word in the second language meet the selection criteria, generating a synthetic code-switched audio sample, of the plurality of synthetic code-switched audio samples, comprising speech of the word in the second language and speech of one or more words in the first language.

6. The method of claim 1, further comprising:
generating, using a text-to-speech (TTS) system, a first audio sample, of the first plurality of audio samples in the first language, while maintaining one more speaker characteristics of a speaker in a second audio sample, of the second plurality of audio samples in the second language; and
generating a synthetic code-switched audio sample, of the plurality of synthetic code-switched audio samples, based at least on the first audio sample and the second audio sample.

7. One or more non-transitory computer-readable media storing instructions which, when executed by one or more processors, cause one or more computer systems to perform asset of operations comprising:
receiving a first plurality of audio samples in a first language and a second plurality of audio samples in a second language;
executing a training process for a speech recognition model, the training process comprising:
selecting a first subset, of the first plurality of audio samples in the first language, and a second subset, of the second plurality of audio samples in the second language, for generating a plurality of synthetic code-switched audio samples;
generating the plurality of synthetic code-switched audio samples based at least on combining the first subset and the second subset, wherein each synthetic code-switched audio sample, of the plurality of synthetic code-switched audio samples, includes audio content in both the first language and the second language;
determining that a first subset of the plurality of synthetic code-switched audio samples satisfies one or more training constraints;
determining that a second subset of the plurality of synthetic code-switched audio samples does not satisfy one or more training constraints; and
training the speech recognition model based at least on the first subset of the plurality of synthetic code-switched audio samples.

8. The one or more non-transitory computer-readable media of claim 7, the set of operations further comprising:
determining that a synthetic code-switched audio sample in the first subset does not exceed a maximum duration threshold.

9. The one or more non-transitory computer-readable media of claim 7, the set of operations further comprising:
selecting a first audio sample, of the first plurality of audio samples in the first language, and selecting a second audio sample, of the second plurality of audio samples in the second language, based at least on determining that a speaker associated with the first audio sample is a same speaker as a speaker associated with the second audio sample; and
generating a synthetic code-switched audio sample, of the plurality of synthetic code-switched audio samples, based at least on the first audio sample and the second audio sample.

10. The one or more non-transitory computer-readable media of claim 7, the set of operations further comprising:
selecting a first audio sample, of the first plurality of audio samples in the first language, and selecting a second audio sample, of the second plurality of audio samples in the second language, based at least on determining that a word in the first language spoken in the first audio sample is code-switch compatible with a word in the second language spoken in the second audio sample; and
generating a synthetic code-switched audio sample, of the plurality of synthetic code-switched audio samples, based at least on the first audio sample and the second audio sample.

11. The one or more non-transitory computer-readable media of claim 7, the set of operations further comprising:
identifying a first document corpus primarily comprising words in in the first language;
detecting one or more occurrences of a word in the second language in the first document corpus;
determining that the one or more occurrences of the word in the second language meet a selection criteria; and
based at least on determining that the one or more occurrences of the word in the second language meet the selection criteria, generating a synthetic code-switched audio sample, of the plurality of synthetic code-switched audio samples, comprising speech of the word in the second language and speech of one or more words in the first language.

12. The one or more non-transitory computer-readable media of claim 7, the set of operations further comprising:
generating, using a text-to-speech (TTS) system, a first audio sample, of the first plurality of audio samples in the first language, while maintaining one more speaker characteristics of a speaker in a second audio sample, of the second plurality of audio samples in the second language; and
generating a synthetic code-switched audio sample, of the plurality of synthetic code-switched audio samples, based at least on the first audio sample and the second audio sample.

13. A system comprising:
one or more computer systems having one or more hardware processors; and
instructions which, when executed by the one or more computer systems, cause the one or more computer systems to perform a set of operations comprising:
receiving a first plurality of audio samples in a first language and a second plurality of audio samples in a second language;
executing a training process for a speech recognition model, the training process comprising:
selecting a first subset, of the first plurality of audio samples in the first language, and a second subset, of the second plurality of audio samples in the second language, for generating a plurality of synthetic code-switched audio samples;
generating the plurality of synthetic code-switched audio samples based at least on combining the first subset and the second subset, wherein each synthetic code-switched audio sample, of the plurality of synthetic code-switched audio samples, includes audio content in both the first language and the second language;
determining that a first subset of the plurality of synthetic code-switched audio samples satisfies one or more training constraints;
determining that a second subset of the plurality of synthetic code-switched audio samples does not satisfy one or more training constraints; and
training the speech recognition model based at least on the first subset of the plurality of synthetic code-switched audio samples.

14. The system of claim 13, the set of operations further comprising:
determining that a synthetic code-switched audio sample in the first subset does not exceed a maximum duration threshold.

15. The system of claim 13, the set of operations further comprising:
selecting a first audio sample, of the first plurality of audio samples in the first language, and selecting a second audio sample, of the second plurality of audio samples in the second language, based at least on determining that a speaker associated with the first audio sample is a same speaker as a speaker associated with the second audio sample; and
generating a synthetic code-switched audio sample, of the plurality of synthetic code-switched audio samples, based at least on the first audio sample and the second audio sample.

16. The system of claim 13, the set of operations further comprising:
selecting a first audio sample, of the first plurality of audio samples in the first language, and selecting a second audio sample, of the second plurality of audio samples in the second language, based at least on determining that a word in the first language spoken in the first audio sample is code-switch compatible with a word in the second language spoken in the second audio sample; and
generating a synthetic code-switched audio sample, of the plurality of synthetic code-switched audio samples, based at least on the first audio sample and the second audio sample.

17. The system of claim 13, the set of operations further comprising:
identifying a first document corpus primarily comprising words in in the first language;
detecting one or more occurrences of a word in the second language in the first document corpus;
determining that the one or more occurrences of the word in the second language meet a selection criteria; and
based at least on determining that the one or more occurrences of the word in the second language meet the selection criteria, generating a synthetic code-switched audio sample, of the plurality of synthetic code-switched audio samples, comprising speech of the word in the second language and speech of one or more words in the first language.

18. The system of claim 13, the set of operations further comprising:
generating, using a text-to-speech (TTS) system, a first audio sample, of the first plurality of audio samples in the first language, while maintaining one more speaker characteristics of a speaker in a second audio sample, of the second plurality of audio samples in the second language; and
generating a synthetic code-switched audio sample, of the plurality of synthetic code-switched audio samples, based at least on the first audio sample and the second audio sample.

19. The system of claim 13, wherein the first language is English and the second language is Hindi.

20. The system of claim 13, wherein the first language is English and the second language is Spanish.
